(19) United States
(12) Patent Application Publication
(10) Pub. No.: US 2024/0386275 A1
(43) Pub. Date: Nov. 21, 2024

(54) SYSTEMS AND METHODS FOR TRAINING DEEP LEARNING MODELS

(71) Applicant: Multicom Technologies Inc., Petersburg (CA)

(72) Inventors: En-hui Yang, Petersburg (CA); Shayan Mohajer Hamidi, Waterloo (CA)

(21) Appl. No.: 18/666,958

(22) Filed: May 17, 2024

Related U.S. Application Data
(60) Provisional application No. 63/503,207, filed on May 19, 2023.

(51) Int. Cl. G06N 3/082

(52) U.S. Cl. CPC G06N 3/082

(57) ABSTRACT

A system, method and computer program product for training a deep neural network. The deep neural network can be trained to minimize an entropy constrained objective function that is defined to constrain the entropy of the weight parameters of the deep neural network. The objective function can be defined to jointly minimize the loss of the deep neural network in performing prediction functions and an entropy of the quantized weight parameters of the deep neural network. The objective function can be defined to also minimize the entropy of quantized activations of the deep neural network. This can provide an improved trade-off between the prediction accuracy of the deep neural network and the compression achievable when encoding the deep neural network.

### CROSS-REFERENCE TO RELATED APPLICATIONS

This application claims the benefit of U.S. Provisional Application No. 63/503,207 filed on May 19, 2023, which is incorporated by reference herein in its entirety.

### FIELD

This document relates to deep learning models. In particular, this document relates to systems and methods for training and compressing deep learning models.

### BACKGROUND

Deep neural networks (DNNs) have demonstrated remarkable performance across diverse applications, from computer vision (see, e.g. A. Krizhevsky, I. Sutskever, and G. E. Hinton, “Imagenet classification with deep convolutional neural networks,” Advances in neural information processing systems, vol. 25, 2012; K. He, X. Zhang, S. Ren, and J. Sun, “Deep residual learning for image recognition,” in Proceedings of the IEEE conference on computer vision and pattern recognition, 2016, pp. 770-778; and M. Tan and Q. Le, “Efficientnet: Rethinking model scaling for convolutional neural networks,” in International conference on machine learning. PMLR, 2019, pp. 6105-6114) to natural language processing (see e.g. J. D. M.-W. C. Kenton and L. K. Toutanova, “Bert: Pre-training of deep bidirectional transformers for language understanding,” in Proceedings of NAACL-HLT, 2019, pp. 4171-4186; and A. Conneau and G. Lample, “Cross-lingual language model pretraining,” Advances in neural information processing systems, vol. 32, 2019). The exceptional performance of these DNNs is largely attributed to their large model sizes, with high-performance models often containing hundreds of millions or even billions of parameters. However, these large models pose challenges for deployment in resource-limited environments due to (i) significant storage overhead, and (ii) intensive computational and memory requirements during both training and post-training inferences.

To partially address the above challenges and facilitate the efficient deployment of large DNNs on resource-limited devices, a multitude of model compression techniques have been proposed. These methods include quantization (see e.g. S. K. Esser, J. L. Mckinstry, D. Bablani, R. Appuswamy, and D. S. Modha, “Learned step size quantization,” in International Conference on Learning Representations (ICLR), 2020; Y. Bhalgat, J. Lee, M. Nagel, T. Blankevoort, and N. Kwak, “Lsq+: Improving low-bit quantization through learnable offsets and better initialization,” in Proceedings of the IEEE/CVF Conference on Computer Vision and Pattern Recognition (CVPR) Workshops, 2020; M. Nagel, M. Fournarakis, R. A. Amjad, Y. Bondarenko, M. van Baalen, and T. Blankevoort, “A white paper on neural network quantization,” arXiv preprint arXiv: 2106.08295, 2021; and H. Peng, J. Wu, Z. Zhang, S. Chen, and H.-T. Zhang, “Deep network quantization via error compensation,” IEEE Transactions on Neural Networks and Learning Systems, vol. 33, no. 9, pp. 4960-4970, 2022), pruning (see e.g. Z. Liu, J. Li, Z. Shen, G. Huang, S. Yan, and C. Zhang, “Learning efficient convolutional networks through network slimming,” in Proceedings of the IEEE international conference on computer vision, 2017, pp. 2736-2744; Z. Liu, M. Sun, T. Zhou, G. Huang, and T. Darrell, “Rethinking the value of network pruning,” in International Conference on Learning Representations, 2018; X. Ma, S. Lin, S. Ye, Z. He, L. Zhang, G. Yuan, S. H. Tan, Z. Li, D. Fan, X. Qian, X. Lin, K. Ma, and Y. Wang, “Non-structured dnn weight pruning—is it beneficial in any platform?” IEEE Transactions on Neural Networks and Learning Systems, vol. 33, no. 9, pp. 4930-4944, 2022; Y.-J. Zheng, S.-B. Chen, C. H. Q. Ding, and B. Luo, “Model compression based on differentiable network channel pruning,” IEEE Transactions on Neural Networks and Learning Systems, vol. 34, no. 12, pp. 10 203-10 212, 2023), and knowledge distillation (see e.g. G. Hinton, O. Vinyals, and J. Dean, “Distilling the knowledge in a neural network,” in NIPS Deep Learning and Representation Learning Workshop, 2015; F. Ding, Y. Yang, H. Hu, V. Krovi, and F. Luo, “Dual-level knowledge distillation via knowledge alignment and correlation,” IEEE Transactions on Neural Networks and Learning Systems, vol. 35, no. 2, pp. 2425-2435, 2024; C. Tan and J. Liu, “Improving knowledge distillation with a customized teacher,” IEEE Transactions on Neural Networks and Learning Systems, vol. 35, no. 2, pp. 2290-2299, 2024; L. Ye, S. M. Hamidi, R. Tan, and E.-H. YANG, “Bayes conditional distribution estimation for knowledge distillation based on conditional mutual information,” in The Twelfth International Conference on Learning Representations, 2024. [Online]. Available: https://openreview.net/forum?id=yV6wwEbtkR). Among these techniques, quantization methods have attracted significant attention due to their promising hardware compatibility across various architectures (see e.g. N. P. Jouppi, C. Young, N. Patil, D. Patterson, G. Agrawal, R. Bajwa, S. Bates, S. Bhatia, N. Boden, A. Borchers et al., “In-datacenter performance analysis of a tensor processing unit,” in Proceedings of the 44th annual international symposium on computer architecture, 2017, pp. 1-12; H. Sharma, J. Park, N. Suda, L. Lai, B. Chau, V. Chandra, and H. Esmaeilzadeh, “Bit fusion: Bit-level dynamically composable architecture for accelerating deep neural network,” in 2018 ACM/IEEE 45th Annual International Symposium on Computer Architecture (ISCA). IEEE, 2018, pp. 764-775).

Quantization can be conducted either during training or after training, with the former called quantization-aware training (QAT) (see e.g. S. K. Esser, J. L. Mckinstry, D. Bablani, R. Appuswamy, and D. S. Modha, “Learned step size quantization,” in International Conference on Learning Representations (ICLR), 2020; Y. Bhalgat, J. Lee, M. Nagel, T. Blankevoort, and N. Kwak, “Lsq+: Improving low-bit quantization through learnable offsets and better initialization,” in Proceedings of the IEEE/CVF Conference on Computer Vision and Pattern Recognition (CVPR) Workshops, 2020; and J. Choi, Z. Wang, S. Venkataramani, I. Pierce, J. Chuang, V. Srinivasan, and K. Gopalakrishnan, “Pact: Parameterized clipping activation for quantized neural networks,” 2018), and the latter called post-training quantization (PTQ) (see e.g. Y. Cai, Z. Yao, Z. Dong, A. Gholami, M. W. Mahoney, and K. Keutzer, “Zeroq: A novel zero shot quantization framework,” in Proceedings of the IEEE/CVF Conference on Computer Vision and Pattern Recognition, 2020, pp. 13 169-13 178; Y. Choukroun, E. Kravchik, F. Yang, and P. Kisilev, “Low-bit quantization of neural networks for efficient inference,” in 2019 IEEE/CVF International Conference on Computer Vision Workshop (ICCVW). IEEE, 2019, pp. 3009-3018). Generally, PTQ methods experience significant performance degradation when deployed for low-bit quantization. On the other hand, existing QAT methods also face several drawbacks, for example: (i) the non-differentiability of quantization functions used in QAT methods necessitates the use of gradient approximation techniques during training (see e.g. Y. Bengio, N. Leonard, and A. Courville, “Estimating or propagating gradients through stochastic neurons for conditional computation,” arXiv preprint arXiv: 1308.3432, 2013; and G. Hinton, “Neural networks for machine learning, lectures 15b,” 2012), leading to inferior results; (ii) QAT methods are often applied to pre-trained full-precision (FP) models in order to control performance degradation (see e.g. S. K. Esser, J. L. Mckinstry, D. Bablani, R. Appuswamy, and D. S. Modha, “Learned step size quantization,” in International Conference on Learning Representations (ICLR), 2020; Y. Bhalgat, J. Lee, M. Nagel, T. Blankevoort, and N. Kwak, “Lsq+: Improving low-bit quantization through learnable offsets and better initialization,” in Proceedings of the IEEE/CVF Conference on Computer Vision and Pattern Recognition (CVPR) Workshops, 2020; M. Nagel, M. Fournarakis, Y. Bondarenko, and T. Blankevoort, “Overcoming oscillations in quantization-aware training,” in International Conference on Machine Learning. PMLR, 2022, pp. 16 318-16 330; C. Tang, K. Ouyang, Z. Wang, Y. Zhu, W. Ji, Y. Wang, and W. Zhu, “Mixed-precision neural network quantization via learned layer-wise importance,” in European Conference on Computer Vision. Springer, 2022, pp. 259-275; and Y. Li, X. Dong, and W. Wang, “Additive powers-of-two quantization: An efficient non-uniform discretization for neural networks,” in International Conference on Learning Representations, 2019) and thus depend on the availability of pre-trained FP models (not always possible), and introduce more training computation complexity when pre-trained FP models are available; and (iii) they often neglect the cost of weight and activation communication required during training in model and data parallelism which is crucial for handling massive models (see e.g. D. Narayanan, M. Shoeybi, J. Casper, P. LeGresley, M. Patwary, V. Korthikanti, D. Vainbrand, P. Kashinkunti, J. Bernauer, B. Catanzaro et al., “Efficient large-scale language model training on gpu clusters using megatron-Im,” in Proceedings of the International Conference for High Performance Computing, Networking, Storage and Analysis, 2021, pp. 1-15). Furthermore, although some QAT methods train models from scratch (see e.g. J. Choi, Z. Wang, S. Venkataramani, I. Pierce, J. Chuang, V. Srinivasan, and K. Gopalakrishnan, “Pact: Parameterized clipping activation for quantized neural networks,” 2018; and D. Zhang, J. Yang, D. Ye, and G. Hua, “Lq-nets: Learned quantization for highly accurate and compact deep neural networks,” in Proceedings of the European conference on computer vision (ECCV), 2018, pp. 365-382), their performance in achieving low-bit quantization is typically inferior compared to methods that start from a pre-trained model.

### SUMMARY

The following summary is intended to introduce the reader to various aspects of the detailed description, but not to define or delimit any invention.

The present disclosure relates to systems, methods and computer program products for training a deep neural network. The deep neural network can be trained to minimize an entropy constrained objective function that is defined to constrain the entropy of the weight parameters of the deep neural network. The objective function can be defined to jointly minimize the loss of the deep neural network in performing prediction functions and an entropy of the quantized weight parameters of the deep neural network. This can provide an improved trade-off between the prediction accuracy of the deep neural network and the compression achievable by the deep neural network. The objective function can also be constrained to minimize the entropy of the activations of the deep neural network. This can reduce the complexity of training and post-training inferences, further enabling deployment of the deep neural network in resource-limited environments.

According to some aspects, the present disclosure provides a method of training a deep neural network, the deep neural network comprising a plurality of layers, the plurality of layers including a plurality of intermediate layers arranged between an input layer and an output layer, wherein each intermediate layer has a plurality of weight parameters, and wherein each intermediate layer is operable to output one or more activations to an adjacent layer in the plurality of layers, the method comprising: inputting a plurality of training data samples into the input layer of the deep neural network, wherein the plurality of training data samples are contained within a training set used to train the deep neural network; and generating a trained deep neural network using the plurality of training data samples by iteratively updating the plurality of weight parameters to optimize an entropy constrained objective function, wherein the entropy constrained objective function is defined to jointly minimize a quantized loss function of the deep neural network and an entropy of a plurality of quantized weight values, wherein the plurality of quantized weight values correspond to the plurality of weight parameters and each quantized weight value is a quantized representation of a corresponding weight parameter in the plurality of weight parameters.

The entropy constrained objective function can be defined using a plurality of quantization function trainable parameters, and generating the trained deep neural network can include iteratively updating the quantization function trainable parameters along with the plurality of weight parameters to optimize the entropy constrained objective function.

The plurality of quantization function trainable parameters can include a plurality of quantization function trainable parameter sets, where each quantization function trainable parameter set corresponds to a particular quantization function trainable parameter type, and the quantization function trainable parameter set for each quantization function trainable parameter type can include a plurality of layer-specific quantization function trainable parameters, where each layer-specific quantization function trainable parameter is associated with a particular layer of the plurality of layers of the deep neural network.

Each layer-specific quantization function trainable parameter can have a corresponding layer-specific learning rate.

Each quantized weight value can be determined from the corresponding weight parameter using a probabilistic weight quantization function that defines a random mapping between a given weight parameter and the corresponding quantized weight value.

Each layer can have a layer-specific probabilistic weight quantization function that defines the random mapping between each weight parameter for that layer and the corresponding quantized weight value.

Iteratively updating the plurality of weight parameters can include, for each iteration, calculating a gradient of the entropy constrained objective function, where calculating the gradient can include a combination of backpropagation over the layers of the deep neural network and using a deterministic weight quantization function as an approximation of the probabilistic weight quantization function to calculate partial derivatives of the entropy constrained objective function.

Each quantized weight value can correspond to a potential quantized weight value from a plurality of potential quantized weight values, and the random mapping can be defined using a conditional probability mass function defined to calculate a plurality of mapping probabilities for each weight parameter, where each mapping probability for a given weight parameter indicates a probability of that given weight parameter being quantized to one of the potential quantized weight values in the plurality of potential quantized weight values.

The conditional probability mass function can be calculated using a softmax operation.

The entropy constrained objective function can be defined to jointly minimize the quantized loss function, the entropy of the plurality of quantized weight values, and an entropy of a plurality of quantized activation values, where the plurality of quantized activation values correspond to a plurality of activations, where the plurality of activations includes the one or more activations provided by each intermediate layer in the plurality of layers, and each quantized activation value is a quantized representation of a corresponding activation in the plurality of activations.

Each quantized activation value can be determined from the corresponding activation using a probabilistic activation quantization function that defines a random mapping between a given activation and the corresponding quantized activation value.

Each layer can have a layer-specific probabilistic activation quantization function that defines the random mapping between each activation output from that layer and the corresponding quantized activation value.

Iteratively updating the plurality of weight parameters can include, for each iteration, calculating a gradient of the entropy constrained objective function, where calculating the gradient can include a combination of backpropagation over the layers of the deep neural network and using a deterministic activation quantization function as an approximation of the probabilistic activation quantization function to calculate partial derivatives of the entropy constrained objective function.

Each quantized activation value can correspond to a potential quantized activation value from a plurality of potential quantized activation values, and the random mapping can be defined using a conditional probability mass function defined to calculate a plurality of mapping probabilities for each activation, where each mapping probability for a given activation indicates a probability of that given activation being quantized to one of the potential quantized activation values in the plurality of potential quantized activation values.

The conditional probability mass function can be calculated using a softmax operation.

At each stage of training the deep neural network: the plurality of weight parameters can be quantized into the corresponding plurality of quantized weight values; and the plurality of activations can be quantized into the corresponding plurality of quantized activation values.

Each quantized activation value can be a partially quantized activation value determined from the corresponding activation using a deterministic activation quantization function.

The deterministic activation quantization function can be configured to define the partially quantized activation value as a weighted average value of a probabilistic quantized activation value determined from the corresponding activation using a probabilistic activation quantization function that defines a random mapping between a given activation and the corresponding quantized activation value.

The trained deep neural network can be generated using a plurality of training computing devices, where each training computing device is associated with one or more layers of the plurality of layers and generating the trained deep neural network can include transmitting activations between the plurality of training computing devices, where prior to transmitting the activations, each activation is quantized into a corresponding quantized activation value determined from the corresponding activation using a probabilistic activation quantization function that defines a random mapping between a given activation and the corresponding quantized activation value.

Each quantized weight value can be a partially quantized weight value determined from the corresponding weight parameter using a deterministic weight quantization function.

The deterministic weight quantization function can be configured to define the partially quantized weight value as a weighted average value of a probabilistic quantized weight value determined from the corresponding weight parameter using a probabilistic weight quantization function that defines a random mapping between a given weight parameter and the corresponding quantized weight value.

The trained deep neural network can be generated using a plurality of training computing devices, where each training computing device can be associated with a device specific batch of training data samples in the plurality of training data samples, and generating the trained deep neural network can include transmitting weight parameters between the plurality of training computing devices, where prior to transmitting the weight parameters, each weight parameter is quantized into a corresponding quantized weight value determined from the corresponding weight parameter using a probabilistic weight quantization function that defines a random mapping between a given weight and the corresponding quantized weight value.

The method can include generating a quantized plurality of trained weight parameters by, after generating the trained deep learning model, quantizing the plurality of weight parameters using a probabilistic weight quantization function that defines a random mapping between a given weight parameter and the corresponding quantized weight value; and storing the trained deep neural network by storing the quantized plurality of trained weight parameters in one or more non-transitory data storage elements.

According to some aspects, there is also provided a computer program product for training a deep neural network, the deep neural network comprising a plurality of layers, the plurality of layers including a plurality of intermediate layers arranged between an input layer and an output layer, wherein each intermediate layer has a plurality of weight parameters, and wherein each intermediate layer is operable to output one or more activations to an adjacent layer in the plurality of layers, the computer program product comprising a non-transitory computer readable medium having computer executable instructions stored thereon, the instructions for configuring one or more processors to perform a method of training the deep neural network, wherein the method comprises: inputting a plurality of training data samples into the input layer of the deep neural network, wherein the plurality of training data samples are contained within a training set used to train the deep neural network; and generating a trained deep neural network using the plurality of training data samples by iteratively updating the plurality of weight parameters to optimize an entropy constrained objective function, wherein the entropy constrained objective function is defined to jointly minimize a quantized loss function of the deep neural network and an entropy of a plurality of quantized weight values, wherein the plurality of quantized weight values correspond to the plurality of weight parameters and each quantized weight value is a quantized representation of a corresponding weight parameter in the plurality of weight parameters.

The entropy constrained objective function can be defined using a plurality of quantization function trainable parameters, and generating the trained deep neural network can include iteratively updating the quantization function trainable parameters along with the plurality of weight parameters to optimize the entropy constrained objective function.

The plurality of quantization function trainable parameters can include a plurality of quantization function trainable parameter sets, where each quantization function trainable parameter set corresponds to a particular quantization function trainable parameter type, and the quantization function trainable parameter set for each quantization function trainable parameter type includes a plurality of layer-specific quantization function trainable parameters, where each layer-specific quantization function trainable parameter is associated with a particular layer of the plurality of layers of the deep neural network.

Each layer-specific quantization function trainable parameter can have a corresponding layer-specific learning rate.

Each quantized weight value can be determined from the corresponding weight parameter using a probabilistic weight quantization function that defines a random mapping between a given weight parameter and the corresponding quantized weight value.

Each layer can have a layer-specific probabilistic weight quantization function that defines the random mapping between each weight parameter for that layer and the corresponding quantized weight value.

Iteratively updating the plurality of weight parameters can include, for each iteration, calculating a gradient of the entropy constrained objective function, where calculating the gradient can include a combination of backpropagation over the layers of the deep neural network and using a deterministic weight quantization function as an approximation of the probabilistic weight quantization function to calculate partial derivatives of the entropy constrained objective function.

Each quantized weight value can correspond to a potential quantized weight value from a plurality of potential quantized weight values, and the random mapping can be defined using a conditional probability mass function defined to calculate a plurality of mapping probabilities for each weight parameter, where each mapping probability for a given weight parameter indicates a probability of that given weight parameter being quantized to one of the potential quantized weight values in the plurality of potential quantized weight values.

The conditional probability mass function is calculated used a softmax operation.

The entropy constrained objective function can be defined to jointly minimize the quantized loss function, the entropy of the plurality of quantized weight values, and an entropy of a plurality of quantized activation values, where the plurality of quantized activation values correspond to a plurality of activations, where the plurality of activations includes the one or more activations provided by each intermediate layer in the plurality of layers, and each quantized activation value is a quantized representation of a corresponding activation in the plurality of activations.

Each quantized activation value can be determined from the corresponding activation using a probabilistic activation quantization function that defines a random mapping between a given activation and the corresponding quantized activation value.

Each layer can have a layer-specific probabilistic activation quantization function that defines the random mapping between each activation output from that layer and the corresponding quantized activation value.

Iteratively updating the plurality of weight parameters can include, for each iteration, calculating a gradient of the entropy constrained objective function, where calculating the gradient comprises a combination of backpropagation over the layers of the deep neural network and using a deterministic activation quantization function as an approximation of the probabilistic activation quantization function to calculate partial derivatives of the entropy constrained objective function.

Each quantized activation value can correspond to a potential quantized activation value from a plurality of potential quantized activation values, and the random mapping can be defined using a conditional probability mass function defined to calculate a plurality of mapping probabilities for each activation, where each mapping probability for a given activation indicates a probability of that given activation being quantized to one of the potential quantized activation values in the plurality of potential quantized activation values.

The conditional probability mass function can be calculated used a softmax operation.

At each stage of training the deep neural network: the plurality of weight parameters can be quantized into the corresponding plurality of quantized weight values; and the plurality of activations can be quantized into the corresponding plurality of quantized activation values.

Each quantized activation value can be a partially quantized activation value determined from the corresponding activation using a deterministic activation quantization function.

The deterministic activation quantization function can be configured to define the partially quantized activation value as a weighted average value of a probabilistic quantized activation value determined from the corresponding activation using a probabilistic activation quantization function that defines a random mapping between a given activation and the corresponding quantized activation value.

The trained deep neural network can be generated using a plurality of training computing devices, where each training computing device is associated with one or more layers of the plurality of layers and generating the trained deep neural network can include transmitting activations between the plurality of training computing devices, where prior to transmitting the activations, each activation is quantized into a corresponding quantized activation value determined from the corresponding activation using a probabilistic activation quantization function that defines a random mapping between a given activation and the corresponding quantized activation value.

Each quantized weight value can be a partially quantized weight value determined from the corresponding weight parameter using a deterministic weight quantization function.

The deterministic weight quantization function can be configured to define the partially quantized weight value as a weighted average value of a probabilistic quantized weight value determined from the corresponding weight parameter using a probabilistic weight quantization function that defines a random mapping between a given weight parameter and the corresponding quantized weight value.

The trained deep neural network can be generated using a plurality of training computing devices, where each training computing device is associated with a device specific batch of training data samples in the plurality of training data samples, and generating the trained deep neural network can include transmitting weight parameters between the plurality of training computing devices, where prior to transmitting the weight parameters, each weight parameter is quantized into a corresponding quantized weight value determined from the corresponding weight parameter using a probabilistic weight quantization function that defines a random mapping between a given weight and the corresponding quantized weight value.

The method can include generating a quantized plurality of trained weight parameters by, after generating the trained deep learning model, quantizing the plurality of weight parameters using a probabilistic weight quantization function that defines a random mapping between a given weight parameter and the corresponding quantized weight value; and storing the trained deep neural network by storing the quantized plurality of trained weight parameters in one or more non-transitory data storage elements.

According to some aspects, there is also provided a system for training a deep neural network, the deep neural network comprising a plurality of layers, the plurality of layers including a plurality of intermediate layers arranged between an input layer and an output layer, wherein each intermediate layer has a plurality of weight parameters, and wherein each intermediate layer is operable to output one or more activations to an adjacent layer in the plurality of layers, the system comprising: one or more processors; and one or more non-transitory storage mediums; wherein the one or more processors are configured to: input a plurality of training data samples into the input layer of the deep neural network, wherein the plurality of training data samples are contained within a training set used to train the deep neural network; generate a trained deep neural network using the plurality of training data samples by iteratively updating the plurality of weight parameters to optimize an entropy constrained objective function, wherein the entropy constrained objective function is defined to jointly minimize a quantized loss function of the deep neural network and an entropy of a plurality of quantized weight values, wherein the plurality of quantized weight values correspond to the plurality of weight parameters and each quantized weight value is a quantized representation of a corresponding weight parameter in the plurality of weight parameters; and storing the trained deep neural network by storing a plurality of trained weight parameters in the one or more non-transitory data storage mediums.

The one or more processors can be further configured to perform the methods of training the deep neural network described herein.

According to some aspects, there is also provided a method of compressing a deep neural network, the deep neural network comprising a plurality of layers, the plurality of layers including a plurality of intermediate layers arranged between an input layer and an output layer, wherein each intermediate layer has a plurality of weight parameters, and wherein each intermediate layer is operable to output one or more activations to an adjacent layer in the plurality of layers, the method comprising: determining a plurality of quantized weight values corresponding to the plurality of weight parameters based on a probabilistic weight quantization function that defines a random mapping between a given weight parameter and the corresponding quantized weight value, where each quantized weight value is a quantized representation of a corresponding weight parameter in the plurality of weight parameters; encoding the plurality of quantized weight values using an entropy coding process; and storing the encoded plurality of quantized weight values in one or more non-transitory data storage mediums.

Each layer can have a layer-specific probabilistic weight quantization function that defines the random mapping between each weight parameter for that layer and the corresponding quantized weight value.

Each quantized weight value can correspond to a potential quantized weight value from a plurality of potential quantized weight values, and the random mapping can be defined using a conditional probability mass function defined to calculate a plurality of mapping probabilities for each weight parameter, where each mapping probability for a given weight parameter indicates a probability of that given weight parameter being quantized to one of the potential quantized weight values in the plurality of potential quantized weight values.

The conditional probability mass function can be calculated using a softmax operation.

The probabilistic weight quantization function can include a plurality of quantization function trainable parameters, and the deep neural network can be trained by iteratively updating the quantization function trainable parameters along with the plurality of weight parameters to optimize an entropy constrained objective function defined to jointly minimize a quantized loss function of the deep neural network and an entropy of the plurality of quantized weight values.

The plurality of quantization function trainable parameters can include a plurality of quantization function trainable parameter sets, where each quantization function trainable parameter set corresponds to a particular quantization function trainable parameter type, and the quantization function trainable parameter set for each quantization function trainable parameter type can include a plurality of layer-specific quantization function trainable parameters, where each layer-specific quantization function trainable parameter is associated with a particular layer of the plurality of layers of the deep neural network.

Each layer-specific quantization function trainable parameter can have a corresponding layer-specific learning rate.

According to some aspects, there is also provided a computer program product for compressing a deep neural network, the deep neural network comprising a plurality of layers, the plurality of layers including a plurality of intermediate layers arranged between an input layer and an output layer, wherein each intermediate layer has a plurality of weight parameters, and wherein each intermediate layer is operable to output one or more activations to an adjacent layer in the plurality of layers, the computer program product comprising a non-transitory computer readable medium having computer executable instructions stored thereon, the instructions for configuring one or more processors to perform a method of compressing the deep neural network, wherein the method comprises: determining a plurality of quantized weight values corresponding to the plurality of weight parameters based on a probabilistic weight quantization function that defines a random mapping between a given weight parameter and the corresponding quantized weight value, where each quantized weight value is a quantized representation of a corresponding weight parameter in the plurality of weight parameters; encoding the plurality of quantized weight values using an entropy coding process; and storing the encoded plurality of quantized weight values in one or more non-transitory data storage mediums.

Each layer can have a layer-specific probabilistic weight quantization function that defines the random mapping between each weight parameter for that layer and the corresponding quantized weight value.

Each quantized weight value can correspond to a potential quantized weight value from a plurality of potential quantized weight values, and the random mapping can be defined using a conditional probability mass function defined to calculate a plurality of mapping probabilities for each weight parameter, where each mapping probability for a given weight parameter indicates a probability of that given weight parameter being quantized to one of the potential quantized weight values in the plurality of potential quantized weight values.

The conditional probability mass function can be calculated using a softmax operation.

The probabilistic weight quantization function can include a plurality of quantization function trainable parameters, and the deep neural network can be trained by iteratively updating the quantization function trainable parameters along with the plurality of weight parameters to optimize an entropy constrained objective function defined to jointly minimize a quantized loss function of the deep neural network and an entropy of the plurality of quantized weight values.

The plurality of quantization function trainable parameters can include a plurality of quantization function trainable parameter sets, where each quantization function trainable parameter set corresponds to a particular quantization function trainable parameter type, and the quantization function trainable parameter set for each quantization function trainable parameter type includes a plurality of layer-specific quantization function trainable parameters, where each layer-specific quantization function trainable parameter is associated with a particular layer of the plurality of layers of the deep neural network.

Each layer-specific quantization function trainable parameter can have a corresponding layer-specific learning rate.

According to some aspects, there is also provided a system for compressing a deep neural network, the deep neural network comprising a plurality of layers, the plurality of layers including a plurality of intermediate layers arranged between an input layer and an output layer, wherein each intermediate layer has a plurality of weight parameters, and wherein each intermediate layer is operable to output one or more activations to an adjacent layer in the plurality of layers, the system comprising: one or more processors; and one or more non-transitory storage mediums; wherein the one or more processors are configured to: determining a plurality of quantized weight values corresponding to the plurality of weight parameters based on a probabilistic weight quantization function that defines a random mapping between a given weight parameter and the corresponding quantized weight value, where each quantized weight value is a quantized representation of a corresponding weight parameter in the plurality of weight parameters; encoding the plurality of quantized weight values using an entropy coding process; and storing the encoded plurality of quantized weight values in the one or more non-transitory data storage mediums.

The one or more processors can be further configured to perform the methods of compressing a deep neural network described herein.

It will be appreciated by a person skilled in the art that an apparatus, computer program product, system, or method disclosed herein may embody any one or more of the features contained herein and that the features may be used in any particular combination or sub-combination.

These and other aspects and features of various examples will be described in greater detail below.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram illustrating an example of a system for training a deep neural network;

FIG. 2A is a flowchart illustrating an example of a method of compressing a deep learning model;

FIG. 2B is a flowchart illustrating an example of a method of training a deep learning model;

FIG. 3A shows a plot of the partial derivative of an example deterministic quantization function Q_{d}(·) with respect to an input value θ for various function parameter values;

FIG. 3B shows a plot of the partial derivative of an example deterministic quantization function Q_{d}(·) with respect to the quantization step-size q for various function parameter values;

FIGS. 4A-4D show plots of quantized values generated by a uniform quantization function Qᵤ(·) and an example deterministic quantization function Q_{d}(·) for various function parameter values;

FIG. 5 is a block diagram illustrating an example of operations performed during the forward and backward training passes of an example method of training a deep learning model;

FIG. 6A shows a plot of trained model accuracy vs. the average number of bits per weight parameter for various example model training methods applied to a ResNet-18 model using an ImageNet training dataset;

FIG. 6B shows a plot of trained model accuracy vs. the average number of bits per activation for various example model training methods applied to a ResNet-18 model using the ImageNet training dataset;

FIG. 6C shows a plot of trained model accuracy vs. the average number of bits per weight parameter for various example model training methods applied to a ResNet-34 model using the ImageNet training dataset;

FIG. 6D shows a plot of trained model accuracy vs. the average number of bits per activation for various example model training methods applied to a ResNet-34 model using the ImageNet training dataset;

FIG. 7A shows a plot of trained model accuracy vs. the average number of bits per weight parameter for various example model training methods applied to a ResNet-20 model using a CIFAR-100 training dataset;

FIG. 7B shows a plot of trained model accuracy vs. the average number of bits per activation for various example model training methods applied to a ResNet-20 model using the CIFAR-100 training dataset;

FIG. 7C shows a plot of trained model accuracy vs. the average number of bits per weight parameter for various example model training methods applied to a ResNet-44 model using the CIFAR-100 training dataset;

FIG. 7D shows a plot of trained model accuracy vs. the average number of bits per activation for various example model training methods applied to a ResNet-44 model using the CIFAR-100 training dataset;

FIG. 7E shows a plot of trained model accuracy vs. the average number of bits per weight parameter for various example model training methods applied to a ResNet-56 model using the CIFAR-100 training dataset;

FIG. 7F shows a plot of trained model accuracy vs. the average number of bits per activation for various example model training methods applied to a ResNet-56 model using the CIFAR-100 training dataset;

FIG. 7G shows a plot of trained model accuracy vs. the average number of bits per weight parameter for various example model training methods applied to a ResNet-110 model using the CIFAR-100 training dataset;

FIG. 7H shows a plot of trained model accuracy vs. the average number of bits per activation for various example model training methods applied to a ResNet-110 model using the CIFAR-100 training dataset;

FIG. 7I shows a plot of trained model accuracy vs. the average number of bits per weight parameter for various example model training methods applied to a VGG13 model using the CIFAR-100 training dataset;

FIG. 7J shows a plot of trained model accuracy vs. the average number of bits per activation for various example model training methods applied to a VGG13 model using the CIFAR-100 training dataset;

FIG. 7K shows a plot of trained model accuracy vs. the average number of bits per weight parameter for various example model training methods applied to a WRN-28-10 model using the CIFAR-100 training dataset;

FIG. 7L shows a plot of trained model accuracy vs. the average number of bits per activation for various example model training methods applied to a WRN-28-10 model using the CIFAR-100 training dataset;

FIG. 8A shows a plot of trained model accuracy vs. the average number of bits per weight parameter for various example model training methods applied to retraining a ResNet-18 model;

FIG. 8B shows a plot of trained model accuracy vs. the average number of bits per activation for various example model training methods applied to retraining the ResNet-18 model of FIG. 8A;

FIG. 8C shows a plot of trained model accuracy vs. the average number of bits per weight parameter for various example model training methods applied to retraining a ResNet-34 model; and

FIG. 8D shows a plot of trained model accuracy vs. the average number of bits per activation for various example model training methods applied to retraining the ResNet-34 model of FIG. 8C.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal, or a mechanical element depending on the particular context. Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Described herein are systems, methods and computer program product for training deep learning models. The systems, methods and computer program products described herein can be used to train deep learning models to reduce the computational complexity and data size of model training, model storage, and post-training inferences while achieving a high-level of model accuracy.

The systems, methods, and devices described herein may be implemented as a combination of hardware or software. In some cases, the systems, methods, and devices described herein may be implemented, at least in part, by using one or more computer programs, executing on one or more programmable devices including at least one processing element, and a data storage element (including volatile and non-volatile memory and/or storage elements). These devices may also have at least one input device (e.g. a pushbutton keyboard, mouse, a touchscreen, and the like), and at least one output device (e.g. a display screen, a printer, a wireless radio, and the like) depending on the nature of the device.

Some elements that are used to implement at least part of the systems, methods, and devices described herein may be implemented via software that is written in a high-level procedural language such as object oriented programming. Accordingly, the program code may be written in any suitable programming language such as Python or C for example. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The present disclosure relates to systems, methods, and computer program products for training and storing deep learning models. The systems, methods and computer program products described herein can provide a high-level of accuracy expected of deep learning models while reducing the size and complexity of the models during both training and post-training inferences. This may facilitate training and deployment of deep learning models in resource-constrained environments.

Deep learning models often involve large model sizes and high computational complexity during both training and post-training inferences. As a result, it can be difficult to train and run large models in a resource-limited environment. Quantization-aware training (QAT) is a method of training a model in which the model weights and activations are quantized, and the forward and backward training passes of the model are performed over quantized weights and activations, while the original floating-point weights are updated (see e.g. S. K. Esser, J. L. Mckinstry, D. Bablani, R. Appuswamy, and D. S. Modha, “Learned step size quantization,” in International Conference on Learning Representations (ICLR), 2020; and B. Rokh, A. Azarpeyvand, and A. Khanteymoori, “A comprehensive survey on model quantization for deep neural networks in image classification,” ACM Transactions on Intelligent Systems and Technology, vol. 14, no. 6, pp. 1-50, 2023). A fundamental challenge for QAT methods is the lack of an interpretable gradient for the quantization function, making gradient-based training impractical without ad hoc approximation. One widely adopted approach to mitigate this challenge is to employ the straight-through estimator (STE) (see e.g. Y. Bengio, N. L′eonard, and A. Courville, “Estimating or propagating gradients through stochastic neurons for conditional computation,” arXiv preprint arXiv: 1308.3432, 2013; and G. Hinton, “Neural networks for machine learning, lectures 15b,” 2012) to approximate the true gradient during training. In practice, this essentially involves approximating the gradient of the rounding operator as 1 within the quantization limits (see e.g. S. K. Esser, J. L. Mckinstry, D. Bablani, R. Appuswamy, and D. S. Modha, “Learned step size quantization,” in International Conference on Learning Representations (ICLR), 2020; and S. Zhou, Z. Ni, X. Zhou, H. Wen, Y. Wu, and Y. Zou, “Dorefa-net: Training low bitwidth convolutional neural networks with low bitwidth gradients,” arXiv preprint arXiv: 1606.06160, 2016).

Some studies have found that the derivative of the clipped ReLU provides a superior approximation compared to the vanilla STE (derivative of identity) (see e.g. Z. Cai, X. He, J. Sun, and N. Vasconcelos, “Deep learning with low precision by half-wave gaussian quantization,” in Conference on Computer Vision and Pattern Recognition (CVPR), 2017; and P. Yin, J. Lyu, S. Zhang, S. J. Osher, Y. Qi, and J. Xin, “Understanding straight-through estimator in training activation quantized neural nets,” in International Conference on Learning Representations (ICLR), 2019). This approach effectively sets the gradient outside the quantization grid to zero, and has become the predominant formulation in existing QAT methods (see e.g. S. K. Esser, J. L. Mckinstry, D. Bablani, R. Appuswamy, and D. S. Modha, “Learned step size quantization,” in International Conference on Learning Representations (ICLR), 2020; J. Choi, Z. Wang, S. Venkataramani, I. Pierce, J. Chuang, V. Srinivasan, and K. Gopalakrishnan, “Pact: Parameterized clipping activation for quantized neural networks,” 2018; and S. Uhlich, L. Mauch, F. Cardinaux, K. Yoshiyama, J. A. Garcia, S. Tiedemann, T. Kemp, and A. Nakamura, “Mixed precision dnns: All you need is a good parametrization,” in International Conference on Learning Representations (ICLR), 2020). Given the sub-optimality of the STE as a gradient approximator, alternative gradient estimators have been proposed which can mainly be categorized into two types: (i) multiplicative methods which apply a scaling to the gradient vectors (see e.g. B. H. J. Lee, D. Kim, “Network quantization with element-wise gradient scaling,” in Conference on Computer Vision and Pattern Recognition (CVPR), 2021; J. Kim, K. Yoo, and N. Kwak, “Position-based scaled gradient for model quantization and pruning,” in Advances in Neural Information Processing Systems (NeuRIPS), 2020; R. Gong, X. Liu, S. Jiang, T. Li, P. Hu, J. Lin, F. Yu, and J. Yan, “Differentiable soft quantization: Bridging full-precision and low-bit neural networks,” International Conference on Computer Vision (ICCV), 2019; and J. Yang, X. Shen, J. Xing, X. Tian, H. Li, B. Deng, J. Huang, and X.-s. Hua, “Quantization networks,” in Conference on Computer Vision and Pattern Recognition (CVPR), 2019), and (ii) additive methods that add an input-independent term to the gradient (see e.g. S. M. Chai, “Quantization-guided training for compact tiny {ml} models,” in Research Symposium on Tiny Machine Learning, 2021; T. Han, D. Li, J. Liu, L. Tian, and Y. Shan, “Improving low-precision network quantization via bin regularization,” in International Conference on Computer Vision (ICCV), 2021; E. Park and S. Yoo, “PROFIT: A novel training method for sub-4-bit mobilenet models,” in European Conference on Computer Vision (ECCV), 2020; and S. Chen, W. Wang, and S. J. Pan, “Metaquant: Learning to quantize by learning to penetrate non-differentiable quantization,” in Neural Information Processing Systems (NeuRIPS), 2019).

While existing QAT methods offer alternatives to STE, they all rely on approximations of the gradient that can result in sub-optimal results. In addition, neither weight entropy nor activation entropy is considered in existing QAT methods.

Parallelism is often employed to assist with training of large deep learning models. Training large models poses a number of significant challenges in that: (i) it is no longer feasible to accommodate the parameters of these models in the main memory of a single computing device, even with the largest GPU configurations available (such as NVIDIA's 80 GB-A100 cards); and (ii) even if the model can be fit into a single GPU (e.g., by utilizing techniques like swapping parameters between host and device memory as in ZeRO-Offload (see e.g. J. Ren, S. Rajbhandari, R. Y. Aminabadi, O. Ruwase, S. Yang, M. Zhang, D. Li, and Y. He, “{Zero-offload}: Democratizing {billion-scale} model training,” in 2021 USENIX Annual Technical Conference (USENIX ATC 21), 2021, pp. 551-564)), the high volume of compute operations required can lead to unrealistically long training times (for instance, training the GPT-3 model with 175 billion parameters (see e.g. T. Brown, B. Mann, N. Ryder, M. Subbiah, J. D. Kaplan, P. Dhariwal, A. Neelakantan, P. Shyam, G. Sastry, A. Askell et al., “Language models are few-shot learners,” Advances in neural information processing systems, vol. 33, pp. 1877-1901, 2020) would necessitate approximately 288 years using a single V100 GPU (see e.g. D. Narayanan, M. Shoeybi, J. Casper, P. LeGresley, M. Patwary, V. Korthikanti, D. Vainbrand, P. Kashinkunti, J. Bernauer, B. Catanzaro et al., “Efficient large-scale language model training on gpu clusters using megatron-Im,” in Proceedings of the International Conference for High Performance Computing, Networking, Storage and Analysis, 2021, pp. 1-15)). As such, the use of parallelism is becoming increasingly essential for training large deep learning model.

Model training parallelism can be separated into two key approaches, namely model parallelism and data parallelism.

Pipeline model parallelism divides the model into multiple chunks of layers and distributes them across different devices (see e.g. Y. Huang, Y. Cheng, A. Bapna, O. Firat, D. Chen, M. Chen, H. Lee, J. Ngiam, Q. V. Le, Y. Wu et al., “Gpipe: Efficient training of giant neural networks using pipeline parallelism,” Advances in neural information processing systems, vol. 32, 2019; A. Kosson, V. Chiley, A. Venigalla, J. Hestness, and U. Koster, “Pipelined backpropagation at scale: training large models without batches,” Proceedings of Machine Learning and Systems, vol. 3, pp. 479-501, 2021; and B. Yang, J. Zhang, J. Li, C. R′e, C. Aberger, and C. De Sa, “Pipemare: Asynchronous pipeline parallel dnn training,” Proceedings of Machine Learning and Systems, vol. 3, pp. 269-296, 2021). During the forward training pass, the activation outputs from one stage are sent to the next stage on a different device. During the backward training pass, gradients are propagated back through the pipeline in a similar fashion. This approach incurs communication overhead between devices when sending activations between pipeline stages. This can potentially negate some of the speedup benefits, and can impact performance, particularly on systems with slower network connections.

In data parallelism, the DNN is replicated across multiple devices (see e.g. J. Dean, G. Corrado, R. Monga, K. Chen, M. Devin, M. Mao, M. Ranzato, A. Senior, P. Tucker, K. Yang et al., “Large scale distributed deep networks,” Advances in neural information processing systems, vol. 25, 2012; and T. Ben-Nun and T. Hoefler, “Demystifying parallel and distributed deep learning: An in-depth concurrency analysis,” ACM Computing Surveys (CSUR), vol. 52, no. 4, pp. 1-43, 2019). The training dataset is divided into mini-batches. Each device receives different mini-batches. Devices simultaneously process their assigned mini-batches, computing weight updates (or gradients) for the same model. Then, each device updates their local model by averaging the weights/gradients received from all the devices.

Given the communication overhead inherent in model parallelism and data parallelism, providing a training method that enables weights and activations to be compressible at any stage of training would be advantageous to improve the speed and performance of model training.

The present disclosure provides methods for training, defining, and deploying deep learning models that can alleviate issues with existing deep learning models and associated training methods. The methods of the present disclosure can be used to substantially compress model weights and activations, reduce computational complexity at both training and post-training inference stages, and enable efficient model/data parallelism. The methods described herein can be used to train deep learning models while satisfying some or all of the following criteria:
Criteria 1: High validation accuracy. Methods described herein can be used to preserve or improve the prediction accuracy achieved by models trained using conventional full-precision methods. The methods described herein can also provide better trade-offs between accuracy and compression as compared to existing model quantization methods.
Criteria 2: Reduced training and inference complexity. Methods described herein can execute the forward and backward passes during training on quantized weights and activations so that a majority of floating-point operations (FLOPs) can be replaced with low-precision computations. This can provide accelerated training times, reduced memory usage, lower power consumption, and enhanced area efficiency (see e.g. A. Zhou, A. Yao, Y. Guo, L. Xu, and Y. Chen, “Incremental network quantization: Towards lossless cnns with low-precision weights,” in International Conference on Learning Representations, 2016; and A. Gholami, S. Kim, Z. Dong, Z. Yao, M. W. Mahoney, and K. Keutzer, “A survey of quantization methods for efficient neural network inference,” in Low-Power Computer Vision. Chapman and Hall/CRC, 2022, pp. 291-326). The methods described herein can generate a trained deep learning model that is defined in a quantized format (i.e. with quantized weight parameters) so that the same benefits in terms of memory, power, area efficiency, etc. can be carried over to post-training inferences.
Criteria 3: Improved model and data parallelism. To train large deep learning models, both pipeline model parallelism and data parallelism are often employed. In pipeline model parallelism, model layers are distributed across multiple devices, necessitating activation communication between devices. In data parallelism, the input dataset is partitioned and distributed among different devices, requiring communication of model weights. The methods described herein can provide improved model/data parallelism by enabling the model weights and activations to be compressible in an information-theoretic sense at any stage of training. This can reduce the cost of weight and activation communication in model/data parallelism.
Criteria 4: Reduced storage complexity. The methods described herein can generate a trained model in which the model weights are compressible in an information-theoretic sense. This can result in a trained model that requires less storage complexity after encoding.

The present disclosure provides a number of features that enable the above criteria to be satisfied. As described in further detail herein below, model weights and/or activations can be quantized using a probabilistic quantization function. A deterministic quantization function (also referred to as a soft differentiable quantization function) can also be used to quantize model weights and/or activations. The deterministic quantization function can enable gradients to be calculated analytically during training of the deep neural network model.

The probabilistic quantization function can be defined using a trainable conditional probability mass function (CPMF). A CPMF can be used to quantize both model weights and activations during training. The CPMFs can also be used to quantize model activations during post-training inferences. This can reduce the complexity of model training and post-training inferences (i.e. satisfying criteria 2).

A deterministic quantization function (or deterministic partial quantization function) can be implemented using an approximation of the CPMF referred to as a soft deterministic differentiable approximation. The soft deterministic differentiable approximation allows for an analytic formula to be applied in computing the partial derivatives of the quantization function with respect to its input θ and quantization step size q.

The probabilistic quantization function and deterministic quantization function used in methods described herein can generate quantized values that are close in value to one another. Accordingly, the analytic formula enabled by the deterministic quantization function can be used as a proxy for gradient calculation during training of a deep neural network model that uses a probabilistic quantization function to quantize weights and/or activations. The analytic formula can also be used to calculate the gradient directly if the deterministic quantization function is used to quantize weights and/or activations during training. This can generate trained models capable of achieving greater validation accuracy than models trained using methods (e.g. QAT methods) that rely primarily on coarse approximations of the gradients (i.e. satisfying criteria 1).

The model training methods described herein can also be used to reduce training computation complexity. Forward and backward passes during training may be executed over quantized weights and activations. This can eliminate a majority of floating-point operations and thus reduce the computation complexity.

The present disclosure can train deep learning models using an objective function that is defined to jointly minimize the loss of the model and the entropy of the quantized model weights and/or quantized activations. By minimizing the entropy of the quantized model weights and/or quantized activations during training, this can ensure that both weights and activations are compressible in an information-theoretic sense at any stage of training (i.e. satisfying criteria 4). This can facilitate parallelism in training the deep learning model, as the quantized weight parameters and/or quantized activations can be transmitted between the devices during training in a compressed format (relative to transmitting the non-quantized values).

As noted above, a probabilistic quantization function can be used to randomly quantize model weights and activations. Marginal probability mass functions (MPMFs) can be calculated for the randomly quantized weights and activations for each layer. When entropy coding (e.g. Huffman coding) is used, the compression rates of quantized weights and activations are roughly equal to the entropy of the MPMFs. The entropy of the MPMFs can thus be constrained during training to enable weight parameters and activations to be compressible at any stage of training. This can also reduce communication overhead between devices where model and/or data parallelism is used to train the model (i.e. satisfying criteria 3).

The methods of the present disclosure can be used to generate a trained deep learning model that is defined in a quantized format with compressible quantized weight parameters. This can reduce the complexity of post-training inferences and model storage.

The methods described herein can further improve the trade-off between validation accuracy and compression while performing both forward and backward training passes with full precision operations. These model training methods can partially quantize the model weights and/or activations using a soft deterministic quantization function that generates an approximation of the probabilistic CPMFs. Model weights and/or activations can then be fully quantized using the CPMFs when inter-device weight and/or activation communications are needed (e.g. due to model and/or data parallelism). Model weights can also be fully quantized at the end of training. This soft quantization training process can allow the gradients of the objective function to be computed analytically without approximation during training at the expense of full precision forward and backward passes. This can provide enhanced accuracy-compression performance for the trained deep learning model.

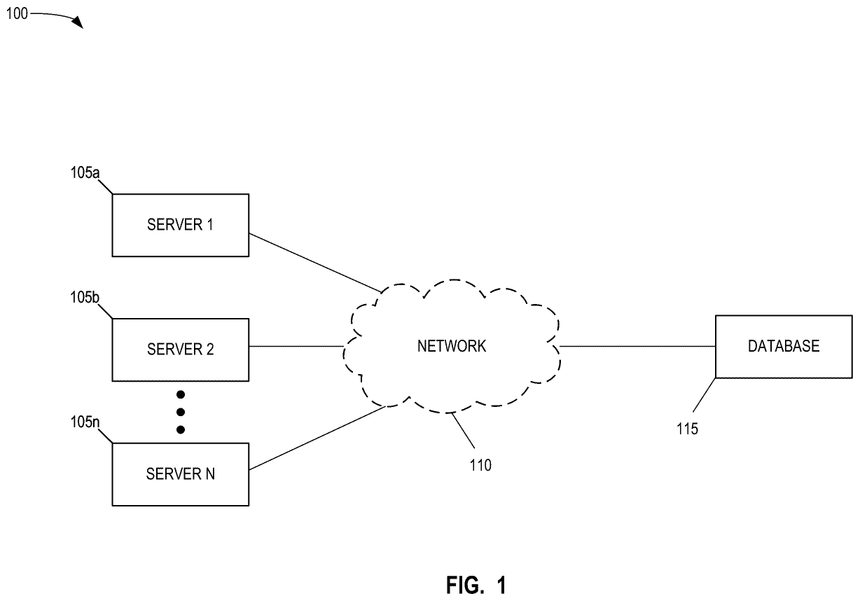

Referring now to FIG. 1, shown therein is a block diagram illustrating an example model training system 100. In the example illustrated, system 100 includes a plurality of computing devices in the form of servers 105a-105n. One or more servers 105 can be configured to perform a method of training a deep learning model and/or compressing a deep learning model, such as the example methods described in further detail herein below.

Each server 105 can be implemented using a processor such as a general purpose microprocessor. The processor controls the operation of the server and in general can be any suitable processor such as a CPU, GPU, microprocessor, controller, digital signal processor, field programmable gate array, application specific integrated circuit, microcontroller, or other suitable computer processor that can provide sufficient processing power processor depending on the desired configuration, purposes and requirements of the system 100.

Server 105 can include the processor, a power supply, memory, and a communication module operatively coupled to the processor.

The memory unit can include both transient and persistent data storage elements, such as RAM, ROM, one or more hard drives, one or more flash drives or some other suitable data storage elements such as disk drives, etc.

As shown in FIG. 1, the servers 105 can be connected to one another through a network 110. The network 110 can communicatively couple the servers 105 to one another, e.g. using a wired or wireless communication protocol (e.g., Bluetooth, Bluetooth Low-Energy, WiFi, ANT+ IEEE 802.11, etc.). The servers 105 can also be communicatively coupled over, for example, a wide area network such as the Internet.

Alternatively or in addition, the servers 105 can be coupled directly to one another, e.g. using a wired connection such as Universal Serial Bus (USB) or other port.

The servers 105 can be configured to communicate with one another to transmit data relating to training and/or storing a deep learning model. For example, the servers 105 may be configured to train a deep learning model using training methods that employ model parallelism and/or data parallelism techniques. Accordingly, the servers 105 can be configured to transmit weight data, activation data, and/or gradient data therebetween during the process of training and/or storing a deep learning model.

The trained neural network model may be stored in non-transitory memory accesible to one or more of the servers 105. The particular parameters and training of the deep neural network model can vary depending on the particular application for which the deep learning model is implemented.

Optionally, system 100 can include a database 115. The database 115 can include suitable data storage elements for persistent data storage. The database 115 can store various different types of data that may be usable by the servers 105, such as parameters of a deep neural network model, trained model weights, training datasets and so forth. Although database 115 is shown separately from the servers 105, it should be understood that database 115 may be co-located with, and/or integrated with, one or more of the servers 105.

To facilitate the discussion that follows, an introduction to the notation being used is provided. For a positive integer N, let [N]≙{1, . . . , N}. Scalars are denoted by lowercase letters (e.g., w), and vectors by bold-face letters (e.g., w). The i-th element of vector w is denoted by w[i]. The length of vector w is denoted by |w|.

The probability of an event E is denoted by P (E). For a discrete random variable X, its probability mass function, expected value, and variance are denoted by [symbol] _{X}, [symbol] {X}, and Var{X}, respectively. For a C-dimensional probability distribution P, the Shannon entropy of P is denoted by H(P)=Σ_{c∈[C]}−P[c] log P[c].

The softmax operation over the vector w is denoted by σ(w). That is, for any i∈[|w|]

$$σ ( w ) [ i ] = \frac{{e}^{w [ i ]}}{{\sum }_{j ∈ [ \vert w \vert ]} {e}^{w [ j ]}} .$$

In an ordinary multi-class classification, let [symbol] ⊆ [symbol] ^{d} be the instance space, and [symbol] =[C] be the label space, where C is the number of classes.

A deep neural network (DNN) is arranged as a cascade of L layers. The DNN includes a plurality of layers, where the number of layers in the plurality of layers is an integer value equal to L.

Each layer l in the plurality of layers has one or more weight parameters. For both fully-connected and convolutional layers wₗ can represent the flattened vector representation of the weight parameters at layer l. Accordingly, the number of weight parameters at layer l equals |wₗ|. In addition, w={wᵢ}_{l∈[L]} represents all the weight parameters in the DNN (i.e. across all layers of the plurality of layers).

The input to the first layer of the DNN is a raw sample denoted by x₀∈ [symbol] . The output of the l-th layer, which is also called an activation map (or layer-specific set of activations), is denoted by vector xₗ. The number of activations at the output of the l-th layer is equal to |xₗ|, and the output logit vector is represented by x_{L}. Let x={xₗ}ₗ₌₁^{L-1}.

Let (X, Y) be a pair of random variables, the distribution of which governs a training set, where X∈ [symbol] represents the raw input sample and Y is the ground truth label of X. In traditional deep learning methods, a classifier is trained by solving the following minimization problem

$${min}_{w} {𝔼}_{( X , Y )} \{ ℒ ( X , Y , w ) \} , \qquad ( 1 )$$

where [symbol] (x₀, y, w) is a real-valued loss function (typically the cross-entropy (CE) loss). The loss function generally represents the convergence (or lack thereof) between the prediction of an input sample to the deep neural network and its actual label (i.e. its labelled value). The classifier is trained by modifying the values of the weight parameters w to minimize the loss function.

To facilitate training of a deep learning model, the model weight parameters and/or model activations can be quantized (or partially quantized). An entropy value for the quantized weights parameters and/or activations can then be calculated. When training the deep learning model, the weight parameters can be updated to optimize an objective function that jointly minimizes a model loss function as well as the weight entropy value and optionally the activation entropy values.

The weights and/or activations can be quantized in various ways. In general, a quantization function (also referred to as a quantizer) can be applied to the weights and/or activations to generate the quantized weights and/or activations. The quantization function takes as an input a weight or an activation and outputs a quantized version of the weight or activation that was received as an input. The parameters of the quantization functions used to quantize the weight parameters (and optionally the activations) can also be updated during the training process to optimize the objective function (i.e. reduce the quantized weight entropy and optionally the quantized activation entropy).

The quantization function(s) can be defined in various ways. For example, a probabilistic quantization function (also referred to as a probabilistic quantizer) can be used to quantize the weight parameters and optionally the activations of the deep learning model. The probabilistic quantizer can be represented by Qₚ(·).

For a b-bit uniform quantization, the quantization index set [symbol] (an indexed plurality of potential quantized values) can be defined as:

$$𝒜 = \{ - {2}^{b - 1} , - {2}^{b - 1} + 1 , … , {2}^{b - 1} - 2 , {2}^{b - 1} - 1 \} . \qquad ( 2 )$$

The quantization index set [symbol] can also be considered a vector of dimension 2^{b}. The reproduction alphabet (a reconstructed plurality of potential quantized values) for the probabilistic quantizer can be defined by multiplying [symbol] by a quantization step-size q resulting in the reproduction alphabet:

$$\hat{𝒜} = q \times [ - {2}^{b - 1} , - {2}^{b - 1} + 1 , … , {2}^{b - 1} - 2 , {2}^{b - 1} - 1 ] . \qquad ( 3 )$$

Without ambiguity, both the indexed quantized values [symbol] and reconstructed quantized values [symbol] can be considered equivalently as the plurality of potential quantized values once the quantization step-size q is known from the context.

Again, the reproduction alphabet [symbol] can be considered both a vector and set.

An input to the quantizer (the value to be quantized) can be represented by θ. θ can be a real value representing either a weight parameter or an activation of the deep neural network. The probabilistic quantization function can be defined to randomly quantize the real-valued input θ (i.e. the real valued weight parameter or activation) to a quantized representation \hat{θ} of that weight parameter or activation. The quantized representation \hat{θ} corresponds to a particular reconstructed quantized value in the reproduction alphabet [symbol] of the quantization function (i.e. \hat{θ}∈ [symbol] ).

For example, the probabilistic quantization function can be defined using a conditional probability mass function (CPMF). The CPMF can be defined to include one or more trainable parameters that allow the CPMF to be trained/adjusted/updated as the deep neural network is being trained.

A trainable CPMF (represented by P_{α}(·|θ)) can be defined over the reproduction alphabet [symbol] (or equivalently the index set [symbol] ) given an input value θ. The trainable CPMF can include a trainable mapping parameter α>0. The trainable CPMF can define a probabilistic function usable to generate a quantized representation of a weight or activation from the real-valued weight parameter or activation according to:

$${P}_{α} ( \hat{θ} \vert θ ) = \frac{{e}^{- {α ( θ - \hat{θ} )}^{2}}}{{\sum }_{j ∈ 𝒜} {e}^{- {α ( θ - jq )}^{2}}} , ∀ \hat{θ} = iq , i ∈ 𝒜 . \qquad ( 4 )$$

For a b-bit quantization, for each input θ a vector of dimension 2^{b} can be defined

$${[ θ ]}_{{2}^{b}} = {[ \underbrace{θ , … , θ} ]}_{{2}^{b} times} , \qquad ( 5 )$$

Equivalently, the CPMF P_{α}(·|θ) can be considered as a vector of dimension 2^{b}.

The conditional probability mass function can then be calculated using a softmax operation according to:

$$[ {P}_{α} ( \cdot \vert θ ) ] = σ ( - α \times {( {[ θ ]}_{{2}^{b}} - 𝒜 )}^{2} ) , \qquad ( 6 )$$

where σ(·) denotes the softmax operation.

The probabilistic quantization function CPMF P_{α}(·|θ) quantizes an input θ to each \hat{θ}∈ [symbol] with a corresponding probability P_{α}(\hat{θ}|θ). The CPMF can be defined to calculate a plurality of mapping probabilities for each input, where each mapping probability for a given input indicates a probability of that given input being quantized to one of the potential quantized values in the plurality of potential quantized values. Accordingly, the probabilistic quantization function defines a random mapping between a given input θ (i.e. a weight parameter or activation) and its corresponding quantized representation (\hat{θ}) as shown in equation (7)

$$\hat{θ} = {Q}_{p} ( θ ) \qquad ( 7 )$$

That is, for a given input θ, the corresponding quantized representation \hat{θ} is a random value in the reproduction alphabet [symbol] with a quantized representation distribution of P_{α}(·|θ).

Although the probabilistic quantization function Qₚ(θ) defines a random mapping, a given input θ is quantized into the nearest quantized representation value in the reproduction alphabet [symbol] with a probability approaching 1 as the trainable mapping parameter α→∞. Accordingly, when the trainable mapping parameter α is large, the quantized representation resulting from the random mapping Qₚ(θ) generated by the probabilistic quantization function for a given input has a high probability of being equal to the uniformly quantized value of that given input.

Although the discussion above relates to uniform quantization of the weights and/or activations, the probabilistic quantizer can also be extended to non-uniform quantization. This can be achieved by replacing the uniformly spaced reproduction alphabet [symbol] in equation (3) with a nonuniformly spaced reproduction reproduction alphabet [symbol] .

A deterministic quantization function (also referred to as a soft deterministic quantizer or deterministic quantization approximation) can be used to quantize the weight parameters and/or activations of the deep learning model. The deterministic quantizer can be represented by Q_{d}(·). The deterministic quantizer can define a partially quantized value from a corresponding input value. For example, the deterministic activation quantization function can define the partially quantized value as a weighted average value of the quantized value generated using the probabilistic quantization function Qₚ(θ).

For example, the deterministic quantizer can define a partially quantized value based on a weighted average of the potential quantized weight values to which a given input value can be mapped. For a given input value θ, the expected distortion (e.g. the squared error) between the given input value θ and the quantized representation \hat{θ} determined by the probabilistic quantizer Qₚ (θ) can be determined. The conditional expectation of the quantized representation \hat{θ} given an input θ can be represented by [symbol] {\hat{θ}|θ}. The deterministic quantizer can be defined to output a partially quantized representation value equal to the conditional expectation value of a quantized representation \hat{θ}:

$${Q}_{d} ( θ ) = 𝔼 \{ \hat{θ} \vert θ \} = {\sum }_{i ∈ 𝒜} {P}_{α} ( iq \vert θ ) iq \qquad ( 8 )$$

For any input θ and trainable mapping parameter α>0,

$$𝔼 \{ {( θ - {Q}_{p} ( θ ) )}^{2} \vert θ \} = {( θ - {Q}_{d} ( θ ) )}^{2} + Var \{ {Q}_{p} ( θ ) \vert θ \} , \qquad ( 9 )$$

where Var{Qₚ(θ)|θ} is the conditional variance of the probabilistic quantizer Qₚ(θ) given a real input θ.

When the trainable mapping parameter α of the probabilistic quantizer is sufficiently large, the conditional variance Var{Qₚ(θ)|θ} becomes negligible. As per equation (9), the expected distortion of the probabilistic quantizer Qₚ(θ) can be approximately equal to the distortion between the input value θ and the quantized representation determined using the deterministic quantization function Q_{d}(θ) when the trainable mapping parameter α is sufficiently large. Thus, the partially quantized representation value generated by the deterministic quantization function Q_{d}(θ) can be used to approximate the quantized representation value generated by the probabilistic quantizer Qₚ(θ).

As noted above, the deterministic quantization function Q_{d}(·) may be referred to as a soft deterministic quantizer or soft deterministic approximation. The quantization is soft or approximate in the sense that the quantized representation is not strictly in the reproduction alphabet [symbol] , but rather maintains a degree of continuous representation.

As can be seen from equations (8) and (4), the deterministic quantization function Q_{d}(·) is analytic as a function of the input value θ and the quantization step-size q. Analytic formulas are also available to calculate the partial derivatives of the deterministic quantization function Q_{d}(·) with respect to the input value θ and the quantization step-size q.

The partial derivative of the deterministic quantization function Q_{d}(θ) with respect to the input value θ can be determined based on the trainable mapping parameter and the variance of the probabilistic quantization function. For example, the partial derivative of the deterministic quantization function Q_{d}(θ) with respect to the input value θ can be determined according to

$$\frac{\partial {Q}_{d} ( θ )}{\partial θ} = 2 α Var \{ {Q}_{p} ( θ ) \} , \qquad ( 10 a )$$

and the partial derivative of the deterministic quantization function Q_{d}(θ) with respect to the quantization step-size q can be determined according to

$$\frac{\partial {Q}_{d} ( θ )}{\partial θ} = \frac{1}{q} ( 𝔼 \{ {Q}_{p} ( θ ) \} + ( 2 α θ ) Var \{ {Q}_{p} ( θ ) \} - ( 2 α ) {Skew}_{u} \{ {Q}_{p} ( θ ) \} ) , \qquad ( 10 b )$$

where for any random variable X,

$${Skew}_{u} ( X ) {=}^{Δ} {\sum }_{x} {x}^{3} {ℙ}_{X} ( x ) - ( {\sum }_{x} x {ℙ}_{X} ( x ) ) ( {\sum }_{x} {x}^{2} {ℙ}_{X} ( x ) ) .$$

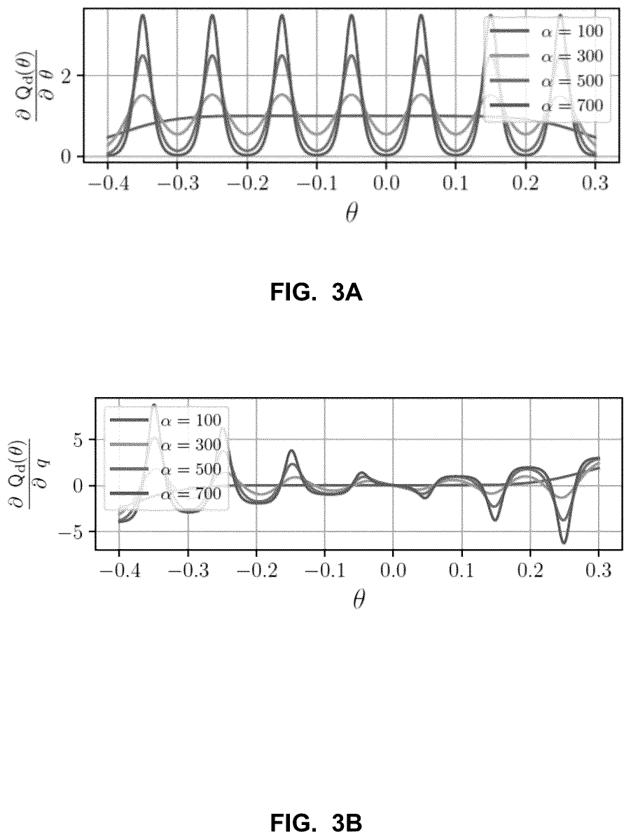

FIG. 3A illustrates a plot of the partial derivative

$$\frac{\partial {Q}_{d} ( θ )}{\partial θ}$$

of the deterministic quantization function Q_{d}(θ) with respect to the input value θ for various example values of the trainable mapping parameter α (100, 300, 500 and 700). FIG. 3B illustrates a plot of the partial derivative

$$\frac{\partial {Q}_{d} ( θ )}{\partial q}$$

of the deterministic quantization function Q_{d}(θ) with respect to quantization step-size q for various example values of the trainable mapping parameter α (100, 300, 500 and 700). For the plots shown in FIGS. 3A and 3B, the quantization bit size b is set to 3 and the quantization step-size q is set to 0.1.

For each input value θ, the nearest potential quantized representation value in the plurality of potential representation values (i.e. in the reproduction alphabet [symbol] ) can be represented by └0┐_{q}. As can be seen from FIG. 3A, as the input value θ moves away from its nearest possible quantized representation value └θ┐_{q} in either direction, the partial derivative

$$\frac{\partial {Q}_{d} ( θ )}{\partial θ}$$

of the deterministic quantization function Q_{d}(θ) with respect to the input value θ increases. This helps the training process push the input value θ (i.e. the weight parameter or activation) towards the potential quantized representation values in the reproduction alphabet [symbol] .

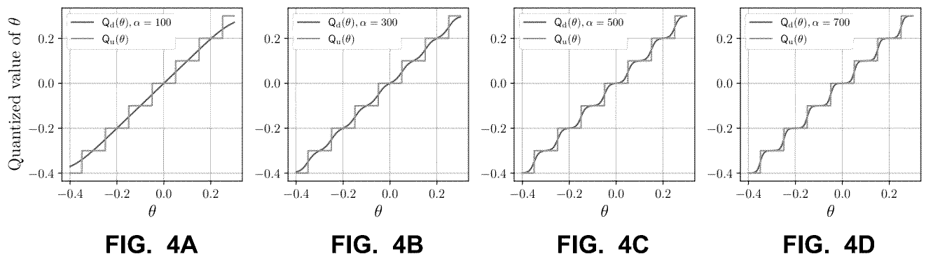

Referring now to FIGS. 4A-4D, shown therein are plots of the quantized representation values generated by the soft deterministic quantizer Q_{d}(θ) and real uniform quantizer Qᵤ(0)=└θ┐_{q} for different values of the trainable mapping parameter α (α=100 in FIG. 4A, α=300 in FIG. 4B, α=500 in FIG. 4C, α=700 in FIG. 4D). As can be seen from FIGS. 4A-4D, as the value of the trainable mapping parameter α increases, the partially quantized representation values generated by the soft deterministic quantizer Q_{d}(·) converge to the quantized representation values generated by a uniform quantizer.

The quantized representation values of the weight parameters and optionally the activations can be integrated into the process of training and deploying deep learning models. For instance, the trainable probabilistic quantizers Qₚ(·) described herein above can be used to quantize both model weight parameters and activations for a deep learning model. For ease of understanding, the following discussion will consider b-bit precision quantization.

In training a deep learning model, the quantized representations of activations may be restricted to non-negative values. In deep neural network architecture, the adoption of rectified linear unit (ReLU) or rectifier activation function ensures that activations take only non-negative values. Thus, the quantization index set for activations (the plurality of potential quantized activation values) can be limited to non-negative values. However, the quantized weight values need not be restricted to non-negative values. Accordingly, the weight parameter quantization index set [symbol] and activation quantization index set [symbol] can be defined as:

$$𝒜 = \{ - {2}^{b - 1} , - {2}^{b - 1} + 1 , … , {2}^{b - 1} - 2 , {2}^{b - 1} - 1 \} , \qquad ( 11 a )$$

$$ℬ = \{ 0 , 1 , … , {2}^{b} - 2 , {2}^{b} - 1 \} . \qquad ( 11 b )$$

The quantization function can be defined to include one or more quantization function trainable parameters that can adjust the quantization of given weight parameters and/or activations over the course of training the deep neural network. The quantization function trainable parameters can include a quantization step-size parameter that adjusts the step-size of the quantized representations output from the quantization function. Alternatively or in addition, the quantization function trainable parameters can include a mapping parameter that can adjust the mapping between the input values and quantized representation values generated by the quantization function.

Additionally, different layers within the deep learning model can have different characteristics. Accordingly, layer-specific quantization functions can be used for different layers to accommodate those differences in characteristics. For instance, different implementations of the trainable probabilistic quantizers Qₚ(·) can be used for different layers. For a given layer l, the reproduction alphabet [symbol] (the plurality of potential quantized weight values) for the weight parameters wₗ of that layer l and the reproduction alphabet [symbol] (the plurality of potential quantized activation values) for the activations xₗ at that layer l, can be defined as

$${\hat{𝒜}}_{l} = {q}_{l} \times \{ - {2}^{b - 1} , - {2}^{b - 1} + 1 , … , {2}^{b - 1} - 2 , {2}^{b - 1} - 1 \} , \qquad ( 12 a )$$

$${\hat{ℬ}}_{l} = {s}_{l} \times [ 0 , 1 , … , {2}^{b} - 2 , {2}^{b} - 1 ] \qquad ( 12 b )$$

where qₗ denotes the quantization step-size for weight parameters w, at layer l, l∈[L] and sₗ denotes the quantization step-sizes for activations xₗ at layer l, l∈[L].

The plurality of quantization function trainable parameters can include a plurality of quantization function trainable parameter sets. Each quantization function trainable parameter set can correspond to a particular quantization function trainable parameter type (e.g. a trainable mapping parameter or a trainable quantization step-size parameter). The quantization function trainable parameter set for each quantization function trainable parameter type can include a plurality of layer-specific quantization function trainable parameters. Each layer-specific quantization function trainable parameter is associated with a particular layer of the plurality of layers of the deep neural network.

For example, the probabilistic weight quantization function for a given layer of a deep neural network can be defined to quantize each weight parameter for that given layer. Each layer-specific probabilistic weight quantization function can include a trainable weight quantization step-size parameter qₗ>0 and/or a trainable weight mapping parameter αₗ>0 that can adjust the quantization of given weight parameters of that layer over the course of training the deep neural network.

As per equation (6) above, to quantize each entry of wₗ (i.e. each weight parameter of layer l) the probabilistic weight quantization function can be defined as the CPMF shown in equation (13):

$$[ {P}_{{α}_{l}} ( \cdot \vert {w}_{l} [ i ] ) ] = σ ( - {α}_{l} \times {( {[ {w}_{l} [ i ] ]}_{{2}^{b}} - {\hat{𝒜}}_{l} )}^{2} ) , \qquad ( 13 )$$

Similarly, the probabilistic activation quantization function for a given layer of a deep neural network can be defined to quantize each activation for that given layer. Each layer-specific probabilistic activation quantization function can include a trainable activation quantization step-size parameters sₗ>0 and/or a trainable activation mapping parameter βₗ>0 that can adjust the quantization of given activations over the course of training the deep neural network.

As per equation (6) above, to quantize each entry of xₗ (i.e. each activation of layer) the probabilistic activation quantization function can be defined using the CPMF shown in equation (14):

$$[ {P}_{{β}_{l}} ( \cdot \vert {x}_{l} [ j ] ) ] = σ ( - {β}_{l} \times {( {[ {x}_{l} [ j ] ]}_{{2}^{b}} - {\hat{ℬ}}_{l} )}^{2} ) \qquad ( 14 )$$

The activations output from the last layer may not be required to be quantized. Accordingly, the plurality of trainable parameters of the probabilistic activation quantization function can be defined to include an activation quantization step-size trainable parameter set s={sₗ}_{l∈[L-1]} and an activation mapping trainable parameter set β={βₗ}_{l∈[L-1]}. As the weight parameters for each layer can be quantized, the plurality of trainable parameters of the probabilistic weight quantization function can be defined to include a weight quantization step-size trainable parameter set q={qₗ}_{l∈[L]} and a weight mapping trainable parameter set α={αₗ}_{l∈[L]}.

The trainable parameters of the weight quantization function and/or activation quantization function can be learned during training of the deep neural network jointly with the weight parameters of the deep neural network.

In training the deep neural network, the training process can optionally be performed using the quantized representations of the weight parameters and activations. Both forward and backward passes can be performed over these quantized weights and activations. Accordingly, the loss function used to train a deep learning model can be redefined as a probabilistically quantized loss function:

$$ℒ ( {x}_{0} , y , \{ {Q}_{p} ( w ) , {Q}_{p} ( x ) \} ) , \qquad ( 15 )$$

where the notation {Qₚ(w), Qₚ(x)} implies that both weight parameters and activations are quantized using the corresponding probabilistic quantization function Qₚ(·).

Training a deep learning neural network model typically involves a backwards training pass in which gradients of the loss function are calculated and propagated through the model in a backwards direction (i.e. in reverse order from the output layer to the input layer). Calculating the gradients of the loss function is often a challenging aspect of training deep learning models, and many existing approaches use approximations of the gradients to reduce the computational complexity of the training process.

As shown by equation (15), the probabilistically quantized loss function involves random jumps from the weight parameters wₗ[i] in each layer to the corresponding quantized representations of those weight parameters Qₚ(wₗ[i]) and from the activations xₗ[j] in each layer to the corresponding quantized representations of those activations Qₚ(xₗ[j]). As such, the probabilistically quantized loss function (15) is not directly differentiable.

In order to calculate the gradients of the probabilistically quantized loss function with respect to the weight parameters w, activations x, weight quantization step size q, activation quantization step size s, weight mapping parameter α, and activation mapping parameter β, the soft deterministic quantizer Q_{d}(·) corresponding to the probabilistic quantizer Qₚ(·) can be used as a proxy to facilitate calculating the gradient during a backwards training pass.

As can be seen from equation (8), the quantized values of the weight parameters wₗ[i] and activations xₗ[j] can be determined as partially quantized values by the layer-specific soft deterministic quantization function Q_{d}(·) according to

$${Q}_{d} ( {w}_{l} [ i ] ) = 𝔼 \{ \hat{w} \vert {w}_{l} [ i ] \} = {\sum }_{j ∈ 𝒜} {P}_{{α}_{l}} ( {jq}_{l} \vert {w}_{l} [ i ] ) {jq}_{l} and \qquad ( 16 a )$$

$$\begin{matrix}{Q}_{d} ( {x}_{l} [ j ] ) = 𝔼 \{ \hat{x} \vert {x}_{l} [ j ] \} = {\sum }_{i ∈ ℬ} {P}_{{β}_{l}} ( {is}_{l} \vert {x}_{l} [ j ] ) {is}_{l} & ( 16 b )\end{matrix}$$

The partial derivative of the probabilistically quantized loss function [symbol] (x₀, y, {Qₚ(w), Qₚ(x)}) with respect to the weight parameters wₗ[i] can then be calculated analytically.

The partial derivatives of the probabilistically quantized loss function [symbol] (x₀, y, {Qₚ(w), Qₚ(x)}) with respect to the activations xₗ[j] can be calculated according to:

$$\frac{\partial ℒ ( {x}_{0} , y , \{ {Q}_{p} ( w ) , {Q}_{p} ( x ) \} )}{\partial {x}_{l} [ j ]} \qquad ( 17 )$$

$$= \frac{\partial ℒ ( {x}_{0} , y , \{ {Q}_{p} ( w ) , {Q}_{p} ( x ) \} )}{\partial {Q}_{p} ( {x}_{l} [ j ] )} \frac{\partial {Q}_{p} ( {x}_{l} [ j ] )}{\partial {x}_{l} [ j ]} \qquad ( 18 )$$

$$\approx \frac{\partial ℒ ( {x}_{0} , y , \{ {Q}_{p} ( w ) , {Q}_{p} ( x ) \} )}{\partial {Q}_{p} ( {x}_{l} [ j ] )} \frac{\partial {Q}_{d} ( {x}_{l} [ j ] )}{\partial {x}_{l} [ j ]} , \qquad ( 19 )$$

where the approximation in (19) is obtained by replacing the probabilistic activation quantization function Qₚ(xₗ[j]) in the second partial derivative of equation (18) with the soft deterministic activation quantization function Q_{d}(xₗ[j]) (i.e. using Q_{d}(xₗ[j]) as an approximation for Qₚ(xₗ[j])).

The first partial derivative in equation (19) can be calculated by backpropagation over the layers of the deep neural network being trained and the second partial derivative can be calculated using equation (10a) with the appropriate corresponding parameters.

The partial derivative of the probabilistically quantized loss function [symbol] (x₀, y, {Qₚ(w), Qₚ(x)}) with respect to the weight parameters wₗ[i] can be calculated according to:

$$\frac{\partial ℒ ( {x}_{0} , y , \{ {Q}_{p} ( w ) , {Q}_{p} ( x ) \} )}{\partial {w}_{l} [ i ]} \qquad ( 20 )$$

$$= {\sum }_{j} \frac{\partial ℒ ( {x}_{0} , y , \{ {Q}_{p} ( w ) , {Q}_{p} ( x ) \} )}{\partial {x}_{l} [ j ]} \frac{\partial {x}_{l} [ j ]}{\partial {Q}_{p} ( {w}_{l} [ i ] )} \frac{\partial {Q}_{p} ( {w}_{l} [ i ] )}{\partial {w}_{l} [ i ]} \qquad ( 21 )$$

$$\approx \frac{\partial {Q}_{d} ( {w}_{l} [ i ] )}{\partial {w}_{l} [ i ]} {\sum }_{j} \frac{\partial ℒ ( {x}_{0} , y , \{ {Q}_{p} ( w ) , {Q}_{p} ( x ) \} )}{\partial {x}_{l} [ j ]} \frac{\partial {x}_{l} [ j ]}{\partial {Q}_{p} ( {w}_{l} [ i ] )} , \qquad ( 22 )$$

where the summation above is taken over all j corresponding to which activation xₗ[j] depends on the probabilistic weight quantization function Qₚ(wₗ[i]).

In equation (22), the first partial derivative can be calculated using equation (10a) with the appropriate corresponding parameters, and the remaining partial derivatives can be determined via backpropagation and equation (19).

The partial derivative of the probabilistically quantized loss function [symbol] (x₀, y, {Qₚ(w), Qₚ(x)}) with respect to the weight quantization step size qi can then be calculated according to:

$$\frac{\partial ℒ ( {x}_{0} , y , \{ {Q}_{p} ( w ) , {Q}_{p} ( x ) \} )}{\partial {q}_{l}} \approx {\sum }_{i ∈ [ \vert {w}_{l} \vert ]} \frac{\partial ℒ ( {x}_{0} , y , \{ {Q}_{p} ( w ) , {Q}_{p} ( x ) \} )}{\partial {Q}_{p} ( {w}_{l} [ i ] )} \frac{\partial {Q}_{d} ( {w}_{l} [ i ] )}{\partial {q}_{l}} , \qquad ( 23 )$$

where the second partial derivative in (23) can be calculated using equation (10b).

Similarly, the partial derivative of the probabilistically quantized loss function [symbol] (x₀, y, {Qₚ(w), Qₚ(x)}) with respect to the activation quantization step size si can be calculated according to:

$$\frac{\partial ℒ ( {x}_{0} , y , \{ {Q}_{p} ( w ) , {Q}_{p} ( x ) \} )}{\partial {s}_{l}} \approx {\sum }_{j ∈ [ \vert {x}_{l} \vert ]} \frac{\partial ℒ ( {x}_{0} , y , \{ {Q}_{p} ( w ) , {Q}_{p} ( x ) \} )}{\partial {Q}_{p} ( {x}_{l} [ j ] )} \frac{\partial {Q}_{d} ( {x}_{l} [ j ] )}{\partial {s}_{l}} . \qquad ( 24 )$$

The partial derivative of the probabilistically quantized loss function [symbol] (x₀, y, {Qₚ(w), Qₚ(x)}) with respect to the weight mapping parameter al can be calculated as:

$$\frac{\partial ℒ ( {x}_{0} , y , \{ {Q}_{p} ( w ) , {Q}_{p} ( x ) \} )}{\partial {α}_{l}} \approx {\sum }_{i ∈ [ \vert {w}_{l} \vert ]} \frac{\partial ℒ ( {x}_{0} , y , \{ {Q}_{p} ( w ) , {Q}_{p} ( x ) \} )}{\partial {Q}_{p} ( {w}_{l} [ i ] )} \frac{\partial {Q}_{d} ( {w}_{l} [ i ] )}{\partial {α}_{l}} , \qquad ( 25 )$$

The partial derivative of the probabilistically quantized loss function [symbol] (x₀, y, {Qₚ(w), Qₚ(x)}) with respect to the activation mapping parameter βₗ can be calculated as:

$$\frac{\partial ℒ ( {x}_{0} , y , \{ {Q}_{p} ( w ) , {Q}_{p} ( x ) \} )}{\partial {β}_{l}} \approx {\sum }_{j ∈ [ \vert {w}_{l} \vert ]} \frac{\partial ℒ ( {x}_{0} , y , \{ {Q}_{p} ( w ) , {Q}_{p} ( x ) \} )}{\partial {Q}_{p} ( {x}_{l} [ j ] )} \frac{\partial {Q}_{d} ( {x}_{l} [ j ] )}{\partial {β}_{l}} , \qquad ( 26 )$$

Both

$$\frac{\partial {Q}_{d} ( {w}_{l} [ i ] )}{\partial {α}_{l}} and \frac{\partial {Q}_{d} ( {x}_{l} [ j ] )}{\partial {β}_{l}}$$

can be computed analytically.

To ensure that the weight parameters and/or activations can be compressed at any point during training of a deep learning model, the entropy of the quantized weight parameters and/or activations can be constrained during the training process.

During the training of the deep neural network model, all of the weight parameters in a given layer l can be randomly quantized using the example probabilistic weight quantization function defined in equation (13). A random weight parameter W at layer l will then have a corresponding quantized weight value Ŵ that is randomly quantized using equation (13). The marginal distribution of the weight parameter W represents the empirical distribution of weight parameters at the layer l. The marginal probability mass functions MPMF of the corresponding quantized weight value Ŵ can then be determined according to:

$${P}_{{α}_{l}} ( \hat{w} ) = \frac{1}{\vert {w}_{l} \vert} {\sum }_{i ∈ [ \vert {w}_{l} \vert ]} {P}_{{α}_{l}} ( \hat{w} \vert {w}_{l} [ i ] ) , ∀ \hat{w} ∈ {\hat{𝒜}}_{l} \qquad ( 27 )$$

If entropy coding (such as Huffman coding) is used to encode all of the quantized weight values for the layer l, the average number of bits per weight parameter (i.e. the average number of bits required to encode each weight parameter) will be roughly equal to the Shannon entropy H( ) of the quantized weight value Ŵ:

$$H ( \hat{W} ) = H ( \frac{1}{\vert {w}_{l} \vert} {\sum }_{i ∈ [ \vert {w}_{l} \vert ]} [ {P}_{{α}_{l}} ( \cdot \vert {w}_{l} [ i ] ) ] )$$

The total number of bits required to represent all of the quantized weight values at a layer l can then be determined as the entropy of the set of quantized weight parameters for the layer l. The entropy of the the set of quantized weight parameters for the layer l can be determined using the number of weight parameters in the layer l and the entropy of a quantized weight value. The entropy of the set of weight parameters for the layer l can be calculated as:

$$H ( {w}_{l} ) = \vert {w}_{l} \vert H ( \frac{1}{\vert {w}_{l} \vert} {\sum }_{i ∈ [ \vert {w}_{l} \vert ]} [ {P}_{{α}_{l}} ( \cdot \vert {w}_{l} [ i ] ) ] ) , \qquad ( 28 )$$

The total number of bits required to represent all of the quantized weight values for the entire deep neural network can be determined as a sum of the entropy of the quantized weight parameters from every layer of the deep neural network. The entropy of the quantized weight parameters from every layer of the deep neural network can be determined as a sum of the entropy of the set of quantized weight parameters for each layer l. The entropy of the quantized weight parameters from every layer of the deep neural network can be calculated using:

$$H ( w ) = {\sum }_{l ∈ [ L ]} H ( {w}_{l} ) , \qquad ( 29 )$$

which may be also be referred to as the description complexity of the deep neural network model.

The total number of bits required to represent all of the quantized activation values at a layer l can be determined as the entropy of the set of quantized activations for the layer l. The entropy of the set of quantized activations for the layer l can be determined using the number of activations in the layer l and the entropy of a quantized activation value. The total number of bits required to represent all of the quantized activation values xₗ at layer l can be calculated according to:

$$H ( {x}_{l} ) = \vert {x}_{l} \vert H ( \frac{1}{\vert {x}_{l} \vert} {\sum }_{i ∈ [ \vert {x}_{l} \vert ]} [ {P}_{{β}_{l}} ( \cdot \vert {x}_{l} [ i ] ) ] ) , \qquad ( 30 )$$

where P_{β}_{ₗ}(·|xₗ[i])) is the probabilistic activation quantization function that may be calculated according to equation (14).

The total number of bits required to represent all of the quantized activation values for the entire deep neural network can be determined as the entropy of the quantized activations from every layer of the deep neural network (other than the last layer, as the activations from the last layer need not be quantized). The entropy of the quantized activations from every layer of the deep neural network can be determined as a sum of the entropy of the set of quantized activations for each layer l (other than the last layer). The entropy of the quantized activations from every layer of the deep neural network can be calculated according to:

$$H ( x ) = {\sum }_{l ∈ [ L - 1 ]} H ( {x}_{l} ) . \qquad ( 31 )$$

To ensure that weight parameters and activations can be compressible at any stage of training, the quantized weight parameter entropy H(w) and quantized activation entropy H(x) can be constrained during training. To do so, the entropy of the quantized weight parameters and/or activations can be incorporated into the objective function that is intended to be optimized during training of the deep learning model.

The deep learning model can thus be trained to optimize an entropy constrained objective function. The entropy constrained objective function can be defined to jointly minimize the quantized weight parameter entropy H(w) and quantized activation entropy H(x) along with the probabilistic quantized loss function [symbol] (x₀, y, {Qₚ(w), Qₚ(x)}). The entropy constrained objective function can be represented by:

$$\hat{ℒ} ( {x}_{0} , y , \{ {Q}_{p} ( w ) , {Q}_{p} ( x ) \} , q , s , a , β ) = ℒ ( {x}_{0} , y , \{ {Q}_{p} ( w ) , {Q}_{p} ( x ) \} ) + γ H ( x ) + λ H ( w ) \qquad ( 32 )$$

$$= {ℒ}_{a} ( {x}_{0} , y , \{ {Q}_{p} ( w ) , {Q}_{p} ( x ) \} ) + λ H ( w ) , \qquad ( 33 )$$

where λ≥0 is an activation hyperparameter and γ≥0 is a weight hyperparameter, and these hyperparameters represent the trade-offs among the three terms (the quantized weight parameter entropy, quantized activation entropy, and probabilistic quantized loss function) in equation (32), and

$${ℒ}_{a} ( {x}_{0} , y , \{ {Q}_{p} ( w ) , {Q}_{p} ( x ) \} ) = ℒ ( {x}_{0} , y , \{ {Q}_{p} ( w ) , {Q}_{p} ( x ) \} ) + γ H ( x ) \qquad ( 34 )$$

Training a deep learning neural network model using an entropy constrained objective function can involve a modified learning process that is defined to solve the entropy-constrained minimization function:

$${min}_{( q , s , α , β , w )} 𝔼 \{ \hat{ℒ} ( X , Y , \{ {Q}_{p} ( w ) , {Q}_{p} ( x ) \} , q , s , α , β ) \} = {min}_{( q , s , α , β , w )} \{ 𝔼 \{ {ℒ}_{a} ( X , Y , \{ {Q}_{p} ( w ) , {Q}_{p} ( x ) \} ) \} + λ H ( w ) \} \qquad ( 35 )$$

$$= {min}_{( q , s , α , β , w )} \{ λ H ( w ) + {𝔼}_{X , Y , {Q}_{p}} \{ {ℒ}_{a} ( X , Y , \{ {Q}_{p} ( w ) , {Q}_{p} ( x ) \} ) \} \} . \qquad ( 36 )$$

In the above, equation (35) results from the fact that the weight parameter entropy H(w) is deterministic given a set of weight parameters w. The expectation function in equation (36) is with respect to a random input sample (X, Y) and random quantizers Qₚ.

When the joint distribution of the random input sample (X, Y) is unknown, the expectation in (36) can be approximated by the corresponding sample mean over a mini-batch [symbol] in the learning process, where for each sample instance in the mini-batch (x₀, y)∈ [symbol] , only one instance of each probabilistic quantizer Qₚ is taken. In this case, the objective function in equation (36) can be represented by:

$${𝒥}_{ℬ} ( \{ {Q}_{p} ( w ) , {Q}_{p} ( x ) \} , q , s , α , β ) = λ H ( w ) + \frac{1}{\vert ℬ \vert} {\sum }_{( {x}_{0} , y ) ∈ ℬ} {ℒ}_{a} ( {x}_{0} , y , \{ {Q}_{p} ( w ) , {Q}_{p} ( x ) \} ) , \qquad ( 37 )$$

where | [symbol] | denotes the size of the mini-batch [symbol] .

The learning process for the deep learning model involves iteratively solving the batch entropy-constrained minimization shown in equation (38) through a sequence of mini-batches:

$${min}_{( q , s , α , β , w )} \{ λ H ( w ) + \frac{1}{\vert ℬ \vert} {\sum }_{( {x}_{0} , y ) ∈ ℬ} {ℒ}_{a} ( {x}_{0} , y , \{ {Q}_{p} ( w ) , {Q}_{p} ( x ) \} ) \} \qquad ( 38 )$$

The set of learning parameters Ω for the entropy constrained objective function can be defined to include the weight parameters and the quantization function trainable parameters (i.e. Ω=(q, s, α, β, w)). The gradient of the probabilistic entropy constrained objective function [symbol] ({Qₚ(w), Qₚ(x)}, q, s, α, β) with respect to the set of learning parameters Ω can then be calculated. The partial derivatives of the quantized weight parameter entropy H(w) with respect to the weight parameters, weight quantization step size, and weight mapping parameter (w, q, α) can be computed analytically.

The gradient of the activation entropy constrained loss function [symbol] ₐ(x₀, y, {Qₚ(w), Qₚ(x)}) with respect to the set of learning parameters Ω can be calculated using equations (17) to (26) and backpropagation with the probabilistic quantized loss function [symbol] replaced by the activation entropy constrained loss function [symbol] ₐ in all equations therein. The gradient of the probabilistic entropy constrained objective function [symbol] ({Qₚ(w), Qₚ(x)}, q, s, α, β) with respect to the set of learning parameters Ω can then be calculated according to:

$$\frac{\partial {𝒥}_{ℬ} ( \{ {Q}_{p} ( w ) , {Q}_{p} ( x ) \} , q , s , α , β )}{\partial Ω} = λ \frac{\partial H ( w )}{\partial Ω} + \frac{1}{\vert ℬ \vert} {\sum }_{( {x}_{0} , y ) ∈ ℬ} \frac{\partial {ℒ}_{a} ( {x}_{0} , y , \{ {Q}_{p} ( w ) , {Q}_{p} ( x ) \} )}{\partial Ω} . \qquad ( 39 )$$

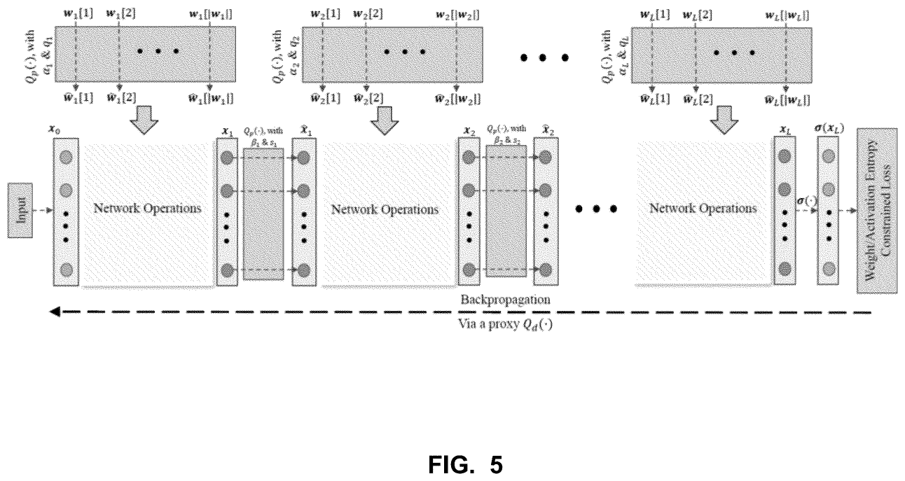

To solve the batch entropy-constrained optimization defined in equation (38) over mini-batches { [symbol] _{b}}_{b∈[B]} of the training dataset, a gradient descent approach can be used to update the set of learning parameters q, s, α, β and w in the batch entropy-constrained minimization (38). The partial derivatives of the probabilistic entropy constrained objective function [symbol] (·) with respect to these five sets of learning parameters can be computed using equation (39). An example algorithm for training a deep learning neural network model can then be defined as Algorithm 1 shown herein below. FIG. 5 provides a block diagram illustrating an example of the operations performed during training according to Algorithm 1.

In Algorithm 1 below, (·)_{b}^{e} indicates trainable parameters of the b-th batch updating during the e-th epoch of the algorithm. Furthermore, the trainable parameter values generated by a given epoch (·)_{B}^{e} are represented by (·)^{e} when needed, and the initialized trainable parameter values for the first input sample of a new epoch are set to be equal to the trainable parameter values generated from the previous epoch (·)₀^{e}=(·)^{e-1}.

### Algorithm 1

Input: All mini-batches { [symbol] _{b}}_{b∈[B]}, maximum number of epochs Eₘₐₓ, λ, γ, the quantization index sets [symbol] and [symbol] , and learning rates {η_{w}, η_{q}, ηₛ, η_{α}, η_{β}}.
1. Initialization: Define the initial values for the set of trainable parameters Ω⁰=(q⁰, s⁰, α⁰, β⁰, w⁰).
2. for each training epoch e=1 to Eₘₐₓ
3. for each b=1 to B
4. Quantize the weight parameters (w)_{b-1}^{e} using the probabilistic weight quantization function Qₚ(·) with the weight quantization step size parameter (q)_{b-1}^{e} and weight mapping parameter (α)_{b-1}^{e}.
5. For each sample (x₀, y)∈ [symbol] _{b}, perform a forward pass based on the quantized weight values Qₚ((w)_{b-1}^{e}) while successively quantizing the activations using the probabilistic activation quantization function Qₚ(·) with the activation quantization step size parameter (s)_{b-1}^{e} resulting from training by the previous mini-batch and activation mapping parameter (β)_{b-1}^{e} resulting from training by the previous mini-batch.
6. For each sample (x₀, y)∈ [symbol] _{b}, perform a backward pass over the quantized weight values and quantized activation values to determine the partial derivatives of the activation entropy constrained quantized loss function with respect to the trainable parameters

$$\frac{\partial {ℒ}_{a} ( {x}_{0} , y , \{ {Q}_{p} ( w ) , {Q}_{p} ( x ) \} )}{\partial Ω} at Ω = {( Ω )}_{b - 1}^{e} . \qquad ( 40 )$$

7. Calculate the partial derivative of the quantized weight entropy with respect to the set of trainable parameters

$$\frac{\partial H ( w )}{\partial Ω} at Ω = {( Ω )}_{b - 1}^{e} .$$

8. Calculate the gradient of the entropy constrained objective function [symbol] ({Qₚ(w), Qₚ(x)}, q, s, α, β) with respect to the set of trainable parameters Ω, e.g. using equation (39) to compute

$$\frac{\partial {𝒥}_{{ℬ}_{b}} ( \{ {Q}_{p} ( w ) , {Q}_{p} ( x ) \} , q , s , α , β )}{\partial Ω} at Ω = {( Ω )}_{b - 1}^{e} .$$

9. Update the set of trainable parameters from the set of trainable parameters determined from the previous batch (Ω)_{b-1}^{e} to an updated set of trainable parameters (Ω)_{b}^{e} by gradient descent with the weight learning rate η_{w} and the layer-specific learning rates defined in equation (41) described below.

10. end for
11. end for
12. Return the trained set of trainable parameters after the maximum
number of epochs Ω^{E}^{ₘₐₓ}.

The learning rates of the deep learning neural network can be adjusted for each set of trainable parameters. For updating the weight parameters w, a weight parameter learning rate η_{w} similar to that of conventional deep learning models can be used. Appropriate learning rates can also be selected for the other four sets of trainable parameters (i.e. the weight quantization step size parameter, the weight mapping parameter, the activation quantization step size parameter, and the activation mapping parameter).

Effective convergence has been shown to occur during training when the ratio of the average update magnitude to the average parameter magnitude remains consistent across all weight layers within a network (see e.g. Y. You, I. Gitman, and B. Ginsburg, “Large batch training of convolutional networks,” arXiv preprint arXiv: 1708.03888, 2017). Additionally, the step-size parameters (weight quantization step size parameter and activation quantization step size parameter) may be expected to decrease with increasing precision, as finer quantization involves smaller quantization step sizes. Similarly, as the mapping parameters at a layer l impact all of the weight parameters and activations at the layer I, the impact of the mapping parameters on the objective function will be the aggregated impact resulting from all of the weight parameters and activations quantized using those mapping parameters. Accordingly, the learning rates for the weight mapping parameter and the activation mapping parameter can be defined to be inversely affected by the number of weight parameters and activations quantized by the weight mapping parameter and the activation mapping parameter respectively.

To account for these factors, the learning rates for a given layer l, l∈[L], can be defined as layer-specific learning rates that are scaled according to:

$${η}_{{q}_{l}} = \frac{1}{\sqrt{\vert {w}_{l} \vert {2}^{b - 1}}} {η}_{q} , \qquad ( 41 a )$$

$${η}_{{s}_{l}} = \frac{1}{\sqrt{\vert {x}_{l} \vert {2}^{b}}} {η}_{s} , \qquad ( 41 b )$$

$${η}_{{a}_{l}} = \frac{1}{\sqrt{\vert {w}_{l} \vert}} {η}_{α} , \qquad ( 41 c )$$

$${η}_{{β}_{l}} = \frac{1}{\sqrt{\vert {x}_{l} \vert}} {η}_{β} , \qquad ( 41 d )$$

for some η_{q}, ηₛ, η_{α}, η_{β}>0.

The methods described herein can also be applied to train a deep learning neural network model using an entropy constrained objective function defined using trainable deterministic quantization functions Q_{d}(·). The training process is similar to that described herein above for training using entropy constrained objective function defined using the probabilistic quantization function, with some minor modifications. The entropy-constrained minimization function using trainable soft deterministic quantization functions Q_{d} (·) can be defined as:

$${min}_{( q , s , α , β , w )} {𝔼}_{( X , Y )} \{ ℒ ( X , Y , \{ {Q}_{d} ( w ) , {Q}_{d} ( x ) \} ) + λ H ( w ) + γ H ( x ) \} \qquad ( 42 )$$

The training process is generally similar to that described in algorithm 1, except that weight parameters and activations are partially quantized using the deterministic quantization function Q_{d}(·). In addition, forward and backward training passes operate using the partially quantized weight parameters and activations with full precision (i.e. using floating-point operations) and compute gradient values analytically without requiring the approximations used in Algorithm 1 (since the partially quantized weight values and activation values are defined using the deterministic quantization function Q_{d}(·)).

Even though the weight parameters and activations are partially quantized during training, the weight parameters and activations are still compressible at any stage of training. The CPMF used to define the probabilistic quantization function can be used to quantize the weight parameters and activations if and when inter-device weight and/or activation communication is required (e.g. to facilitate parallelism in training the DNN). The weight parameters of the trained deep neural network model can also be quantized using the probabilistic quantization function once training is complete, such that the trained deep neural network model requires substantially reduced storage capacity.

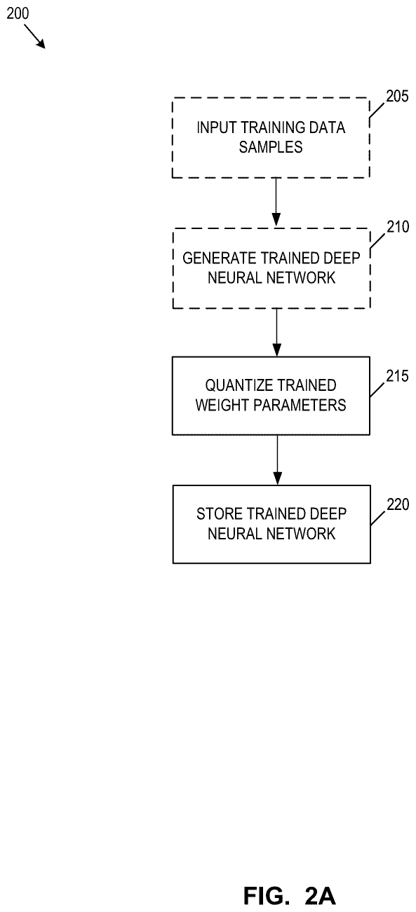

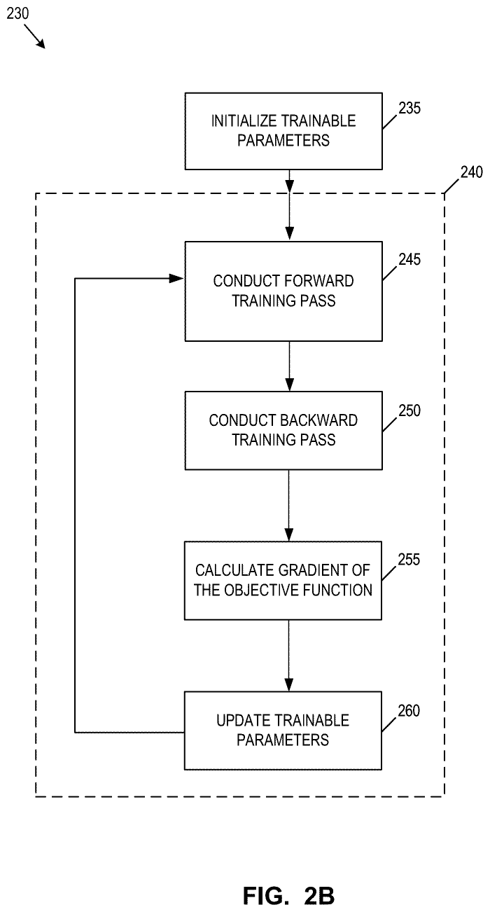

Referring now to FIG. 2A, shown therein is an example method 200 for compressing a deep neural network. The method 200 may be used with model training system such as system 100 for example. Method 200 is an example of a method for compressing a deep neural network that may reduce the complexity of post-training inferences and model storage while retaining or improving a high level of model accuracy.

A deep neural network generally includes a plurality of layers arranged between an input layer and an output layer. The plurality of layers includes a plurality of intermediate layers arranged between the input layer and the output layer. Each intermediate layer has a plurality of weight parameters. Each intermediate layer is operable to output one or more activations to an adjacent layer in the plurality of layers. Inputs are provided to the input layer and in the case of a classification model, a predicted classification or probability distribution of classifications is output from the output layer identifying a predicted classification for the input.

Optionally, in order to compress a deep neural network model, the model can be trained as part of the method for compressing the deep neural network model. Alternatively, a trained model can be received and then compressed directly using the methods described herein (e.g. using the quantization functions described herein above).

Optionally, at 205, a plurality of training data samples can be input into the input layer of the deep neural network. The plurality of training data samples can be contained within a training set used to train the deep neural network.

Optionally, at 210, the trained deep neural network can be generated using the plurality of training data samples. Generating the trained deep neural network can include iteratively updating the plurality of weight parameters to optimize an entropy constrained objective function. The entropy constrained objective function can be defined to jointly minimize a quantized loss function of the deep neural network and an entropy of a plurality of quantized weight values. The plurality of quantized weight values can correspond to the plurality of weight parameters of the deep neural network. Each quantized weight value can be a quantized representation of a corresponding weight parameter in the plurality of weight parameters.

Optionally, the entropy constrained objective function can be defined to jointly minimize the quantized loss function, the entropy of the plurality of quantized weight values, and an entropy of a plurality of quantized activation values. The plurality of quantized activation values can correspond to a plurality of activations output by the layers of the deep neural network. The plurality of activations can include the one or more activations provided by each intermediate layer in the plurality of layers. Each quantized activation value can a quantized representation of a corresponding activation in the plurality of activations.

An example method 230 for generating a trained deep neural network is shown in FIG. 2B described herein below.

At 215, the trained weight parameters of the trained deep neural network can be quantized. After generating the trained deep learning model (or after receiving a trained deep learning model), a quantized plurality of trained weight parameters can be generated by quantizing the plurality of weight parameters (of the trained deep neural network) using a probabilistic weight quantization function. The probabilistic weight quantization function can define a random mapping between a given weight parameter and the corresponding quantized weight value. Each quantized weight value can be determined from the corresponding weight parameter using the probabilistic weight quantization function.

Optionally, each layer (or at least each intermediate layer) of the deep neural network can have an associated layer-specific probabilistic weight quantization function. Each layer-specific probabilistic weight quantization function can define a layer-specific random mapping between each weight parameter for that layer and the corresponding quantized weight value.

The mapping defined by the probabilistic weight quantization function can be defined using a plurality of potential quantized weight values. Each quantized weight value can be defined to corresponds to one of the potential quantized weight values from the plurality of potential quantized weight values. The plurality of potential quantized weight values can be defined as the weight quantization index set for the probabilistic weight quantization function.

The random mapping of the probabilistic weight quantization function can be defined using a conditional probability mass function defined to calculate a plurality of mapping probabilities for each weight parameter. Each mapping probability for a given weight parameter indicates a probability of that given weight parameter being quantized to one of the potential quantized weight values in the plurality of potential quantized weight values. Optionally, the conditional probability mass function can be calculated using a softmax operation.

At 220, the trained deep neural network can be stored by storing the quantized plurality of trained weight parameters from 215 in one or more non-transitory data storage elements. The plurality of quantized weight values can be encoded using an entropy coding method, e.g. Huffman coding. The encoded plurality of quantized weight values can then be stored in one or more non-transitory data storage mediums. This can enable the deep neural network to be stored in a compressed format, reducing the storage complexity of the trained model.

Referring now to FIG. 2B, shown therein is an example method 230 for training a deep neural network. The method 230 may be used with model training system such as system 100 for example. Method 230 is an example of a method for training a deep neural network that may reduce the complexity of training, post-training inferences and model storage while retaining or improving a high level of model accuracy.

Similar to method 200, the deep neural network generally includes a plurality of layers arranged between an input layer and an output layer. The plurality of layers includes a plurality of intermediate layers arranged between the input layer and the output layer. Each intermediate layer has a plurality of weight parameters. Each intermediate layer is operable to output one or more activations to an adjacent layer in the plurality of layers. Inputs are provided to the input layer and in the case of a classification model, a predicted classification or probability distribution of classifications is output from the output layer identifying a predicted classification for the input.

At 235, the trainable parameters of the deep neural network can be initialized. The trainable parameters of the deep neural network generally refer to those parameters of the deep neural network that can be updated to minimize the objective function defined for the training of the deep neural network.

In method 230, the deep neural network can be trained to optimize an entropy constrained objective function. The entropy constrained objective function can be defined to jointly minimize a quantized loss function of the deep neural network and an entropy of a plurality of quantized weight values. Optionally, the entropy constrained objective function can be defined to jointly minimize the quantized loss function, the entropy of the plurality of quantized weight values, and an entropy of a plurality of quantized activation values.

The entropy constrained objective function can be defined using a plurality of quantization function trainable parameters. The quantization function trainable parameters can include parameters of the weight quantization function and optionally the activation quantization function that can be adjusted/updated in order to optimize the objective function.

The plurality of quantization function trainable parameters can include a plurality of quantization function trainable parameter sets. Each quantization function trainable parameter set can correspond to a particular quantization function trainable parameter type, such as a quantization step-size parameter or a mapping parameter for example. The quantization function trainable parameter set for each quantization function trainable parameter type can include a plurality of layer-specific quantization function trainable parameters. Each layer-specific quantization function trainable parameter can be associated with a particular layer of the plurality of layers of the deep neural network.

Optionally, each layer-specific quantization function trainable parameter can have a corresponding layer-specific learning rate. For example, the learning rates for mapping parameters can be scaled by the number of values (e.g. weight parameters or activations) in a given layer that will be affected by those mapping parameters.

At 240, the plurality of weight parameters of the deep neural network can be iteratively updated to optimize an entropy constrained objective function. As shown in FIG. 2B, step 240 includes an iterative set of training steps that can be used to update the weight parameters in order to optimize the entropy constrained objective function.

Optionally, the plurality of weight parameters can be quantized into the corresponding plurality of quantized weight values at each stage (or iteration) of training the deep neural network. Also optionally, the plurality of activations can be quantized into the corresponding plurality of quantized activation values at each stage (or iteration) of training the deep neural network. This may reduce the computation complexity of training the deep neural network.

Optionally, the weight parameters can be quantized using a probabilistic weight quantization function (e.g. as described at step 215 of method 200). The plurality of activations can also be quantized into the corresponding plurality of quantized activation values using a probabilistic activation quantization function. The probabilistic activation quantization function can be defined in a similar way to the probabilistic weight quantization function.

Alternatively, each quantized weight value can be defined as a partially quantized weight value (or an approximated quantized weight value) determined from the corresponding weight parameter using a deterministic weight quantization function. The deterministic weight quantization function can be configured to define the partially quantized weight value as a weighted average value of a probabilistic quantized weight value determined from the corresponding weight parameter. The probabilistic quantized weight value can be determined using the probabilistic weight quantization function that defines a random mapping between a given weight parameter and the corresponding quantized weight value.

Similarly, each quantized activation value can be defined as a partially quantized activation value (or an approximated quantized activation value) determined from the corresponding activation using a deterministic activation quantization function. The deterministic activation quantization function can be configured to define the partially quantized activation value as a weighted average value of a probabilistic quantized activation value determined from the corresponding activation. The probabilistic quantized activation value can be determined using the probabilistic activation quantization function that defines a random mapping between a given activation and the corresponding quantized activation value.

Quantizing the plurality of weight parameters and activations can incur computational overhead. For instance, the quantization functions may be implemented using a softmax operation that is computationally time-consuming. Quantizing the activation maps for each sample input to the deep neural network can thus introduce time complexity into the training process. To reduce the additional computational overhead, the random mapping defined by the activation quantization functions can optionally be constrained to include non-zero mapping probabilities for only the potential quantized activation values with the greatest probability for a given activation while the mapping probabilities for all other potential quantized activation values are set to zero. For example, the random mapping generated by the activation quantization function can be limited to non-zero mapping probabilities for only a threshold number (e.g. 5) of potential quantized activation values with the greatest mapping probability for a given activation. The particular threshold number can be selected for a given implementation to provide a desired trade-off between reduced computational complexity and model accuracy.

Optionally, the weight quantization function may also be constrained in a similar manner. However, the weight quantization function may not be constrained (even in implementations where the activation quantization function is constrained) since the weight parameters are quantized only once for a given set of input training samples, thus reducing the time complexity resulting from the softmax operation.

An example algorithm 1 for implementing the method of iteratively updating the trainable parameters is described in further detail herein below.

At 245, a forward training pass of the deep neural network is performed for a given input sample from the plurality of training data samples (e.g. from step 205 of method 200). The input sample is provided as an input to the input layer of the deep neural network. The activations generated by each layer of the deep neural network can then be fed through the deep neural network to the output layer to output a prediction result for the input sample.

The forward training pass can be performed using quantized weight parameters in each layer of the deep neural network. For instance, the weight parameters can be quantized using a probabilistic weight quantization function with the weight quantization step size parameter and weight mapping parameter defined based on a previous batch or epoch of training samples (or an initialized value). This can reduce the computational complexity of the forward training pass (as well as the backwards training pass in step 250).

Alternatively, the weight parameters can be partially quantized weight values generated using a deterministic weight quantization function with the weight quantization step size parameter and weight mapping parameter defined based on a previous batch or epoch of training samples (or an initialized value). Accordingly, the forward training pass (and backwards training pass in step 250) may provide for full-precision training of the deep neural network as the partially quantized weight values can remain as continuous values.

The activations generated in the forward training pass can also be quantized using a probabilistic activation quantization function with the activation quantization step size parameter and activation mapping parameter defined based on a previous batch or epoch of training samples (or an initialized value). This can reduce the computational complexity of the forward training pass (as well as the backwards training pass in step 250).

Alternatively, the activations can be partially quantized activation values generated using a deterministic activation quantization function with the activation quantization step size parameter and activation mapping parameter defined based on a previous batch or epoch of training samples (or an initialized value). Accordingly, the forward training pass (and backwards training pass in step 250) may provide for full-precision training of the deep neural network as the partially quantized activation values can remain as continuous values.

At 250, a backwards training pass can be performed for the sample input at 245. The backwards training pass can be performed using the quantized weight parameters and the quantized activations generated at 245.

Optionally, as noted at 245, the quantized weight parameters and quantized activations can be generated using respective probabilistic quantization functions. Alternatively, the quantized weight parameters and quantized activations can be partially quantized values generated using respective deterministic quantization functions.

At 255, the gradient of the objective function can be calculated. The gradient can be calculated using a combination of backpropagation (i.e. from step 250) over the layers of the deep neural network and calculating partial derivates of the entropy constrained objective function based on a deterministic quantization function.

Where the quantized weight parameters and quantized activations are generated using probabilistic quantization functions, deterministic quantization functions can be used as an approximation of the probabilistic quantization functions to allow the partial derivatives of the entropy constrained objective function to be calculated analytically.

Where the quantized weight parameters and quantized activations are generated using deterministic quantization functions, the partial derivatives of the entropy constrained objective function can be calculated analytically without requiring approximations.

At 260, the trainable parameters of the deep neural network can be updated based on the gradients calculated in step 255. The quantization function trainable parameters and the plurality of weight parameters can be updated to optimize the entropy constrained objective function. For instance, various optimization techniques such as gradient descent optimization can be used to update the quantization function trainable parameters and the plurality of weight parameters. Method 230 can then return to step 245 to continue training the deep neural network for a subsequent batch of training sample inputs.

Optionally, the deep neural network can be trained using a plurality of training computing devices. Each training computing device can be associated with a device specific batch of training data samples in the plurality of training data samples. Generating the trained deep neural network can thus include transmitting weight parameters between the plurality of training computing devices. Prior to transmitting the weight parameters, each weight parameter can quantized into a corresponding quantized weight value determined from the corresponding weight parameter using a probabilistic weight quantization function that defines a random mapping between a given weight and the corresponding quantized weight value. The weight parameters can be quantized prior to transmission using the probabilistic weight quantization function even in implementations where the deterministic weight quantization function is used to quantize weight parameters for the training process internal to an individual training computing device (as well as implementations where the probabilistic weight quantization function is used for the training process internal to an individual training computing device).

Alternatively or in addition, each training computing device can be associated with one or more layers of the plurality of layers. Generating the trained deep neural network can thus include transmitting activations between the plurality of training computing devices. Prior to transmitting the activations, each activation can quantized into a corresponding quantized activation value determined from the corresponding activation using a probabilistic activation quantization function that defines a random mapping between a given activation and the corresponding quantized activation value. The activations can be quantized prior to transmission using the probabilistic activation quantization function even in implementations where the deterministic activation quantization function is used to quantize activations for the training process internal to an individual training computing device (as well as implementations where the probabilistic activation quantization function is used for the training process internal to an individual training computing device).

### EXAMPLES

Example implementations of the methods described herein were used to train various deep neural network models using the CIFAR-100 (see e.g. A. Krizhevsky, G. Hinton et al., “Learning multiple layers of features from tiny images,” University of Toronto, Tech. Rep., 2009) and ImageNet (see e.g. A. Krizhevsky, I. Sutskever, and G. E. Hinton, “Imagenet classification with deep convolutional neural networks,” Advances in neural information processing systems, vol. 25, 2012) datasets alongside various existing model training methods. The results of these tests demonstrated that the disclosed methods provide superior performance when compared to existing state-of-the-art quantization aware training methods.

The inventors compared the accuracy of each trained deep neural network vs. the average number of bits required to represent the weight parameters and/or activations of that deep neural network. The average number of bits required to represent the weights of a trained deep neural network were defined as:

$$average \# of bits per weight = \frac{{\sum }_{l = 1}^{L} \vert {w}_{l} \vert {b}_{{w}_{l}}}{{\sum }_{l = 1}^{L} \vert {w}_{l} \vert} , \qquad ( 43 a )$$

while, the average number of bits required to represent the activations of a trained deep neural network were defined as:

$$average \# of bits per activation = \frac{{\sum }_{l = 1}^{L - 1} \vert {x}_{l} \vert {b}_{{x}_{l}}}{{\sum }_{l = 1}^{L - 1} \vert {x}_{l} \vert} , \qquad ( 43 b )$$

where b_{w}_{ₗ} denotes the average number of bits required per weight parameter to represent the l-th layer of the tested deep neural network when using Huffman coding and bₓ_{ₗ} denotes the average number of bits required per activation to represent the l-th layer of the tested deep neural network when using Huffman coding.

To calculate bₓ_{ₗ}, an inference was performed over the samples in a mini-batch of the training dataset to obtain the respective activation maps xₗ for these samples, and the activations in the generated activation maps were encoded using Huffman coding.

Huffman coding was also applied to encode the weights and activations of the fully-trained models obtained using the benchmark methods as well of the models trained using implementations of the disclosed training methods.

In the example implementation tested, the random mapping generated by the activation quantization function was limited to non-zero mapping probabilities for only the 5 potential quantized activation values with the greatest mapping probability for a given activation. The probabilistic weight quantization function and the deterministic weight quantization function were not be constrained.

In the implementations tested, the weight parameters for all layers except the first and last layers were quantized to a low bit-width. The weight parameters in the first and last layers of the deep neural network were maintained at 8-bits, similar to the approach used in benchmark methods (see e.g. S. K. Esser, J. L. Mckinstry, D. Bablani, R. Appuswamy, and D. S. Modha, “Learned step size quantization,” in International Conference on Learning Representations (ICLR), 2020; Y. Bhalgat, J. Lee, M. Nagel, T. Blankevoort, and N. Kwak, “Lsq+: Improving low-bit quantization through learnable offsets and better initialization,” in Proceedings of the IEEE/CVF Conference on Computer Vision and Pattern Recognition (CVPR) Workshops, 2020; and D. Zhang, J. Yang, D. Ye, and G. Hua, “Lq-nets: Learned quantization for highly accurate and compact deep neural networks,” in Proceedings of the European conference on computer vision (ECCV), 2018, pp. 365-382).

The test results described herein below were generated using a bit size of six bits b=6 for quantizing both weights and activations as per Algorithm 1, while different values of the objective function hyperparameters λ and γ were tested. A similar optimizer was used for all of the trainable parameters, including the weight parameters w and the quantization function trainable parameters q, s, α, β. The same values for the learning rates {η_{w}, η_{q}, ηₛ, η_{α}, η_{β}} were used in each implementation tested. The learning rates for the quantization function trainable parameters were adaptively scaled layer-wise during training according to equation (41).

In the implementation tested, the quantization step size parameters were initialized to

$${q}^{0} = \frac{2 \overline{\vert w \vert}}{\sqrt{{2}^{b - 1}}} and {s}^{0} = \frac{2 \overline{\vert x \vert}}{\sqrt{{2}^{b - 1}}} ,$$

where |̅w̅|̅ is the average of absolute values of initial weight parameters, and |̅x̅|̅ is the average of absolute values for the first batch of activations. In addition, the mapping parameters were initialized to α⁰=[500]_{L} and β⁰=[500]_{L-1}.

Implementations of the methods described herein were used to train two models from ResNet family, namely ResNet-18 and ResNet-34 (see e.g. K. He, X. Zhang, S. Ren, and J. Sun, “Deep residual learning for image recognition,” in Proceedings of the IEEE conference on computer vision and pattern recognition, 2016, pp. 770-778). These models were trained using ImageNet as the set of training data samples. ImageNet is a large-scale dataset used in visual recognition tasks, containing around 1.2 million training samples and 50,000 validation images.

Two implementations of the methods described herein, one using probabilistic quantization functions to quantize the weight parameters and activations and one using deterministic quantization functions to quantize the weight parameters and activations, were tested against several QAT training methods, including LSQ (see S. K. Esser, J. L. Mckinstry, D. Bablani, R. Appuswamy, and D. S. Modha, “Learned step size quantization,” in International Conference on Learning Representations (ICLR), 2020), PACT (see J. Choi, Z. Wang, S. Venkataramani, I. Pierce, J. Chuang, V. Srinivasan, and K. Gopalakrishnan, “Pact: Parameterized clipping activation for quantized neural networks,” 2018), and LQ-Nets (see D. Zhang, J. Yang, D. Ye, and G. Hua, “Lq-nets: Learned quantization for highly accurate and compact deep neural networks,” in Proceedings of the European conference on computer vision (ECCV), 2018, pp. 365-382). Each of the methods was tested while training the models from scratch.

The deep neural network models were trained using stochastic gradient descent optimizer with a momentum of 0.9, a weight decay of 0.0001, and a batch size of 256. The models were trained for 90 epochs, and adopted an initial learning rate of 0.1, which was further divided by 10 at the 30-th and 60-th epochs. The methods described herein were implemented using Algorithm 1 for different pairs of λ and γ values (λ, γ)={(0, 0), (0.01, 0.01), . . . , (0.09, 0.09)}.

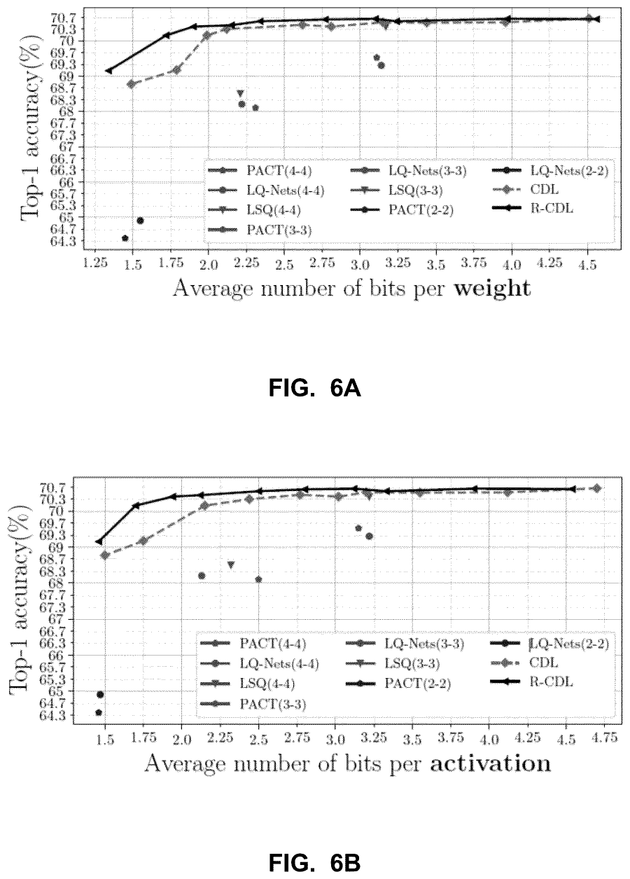

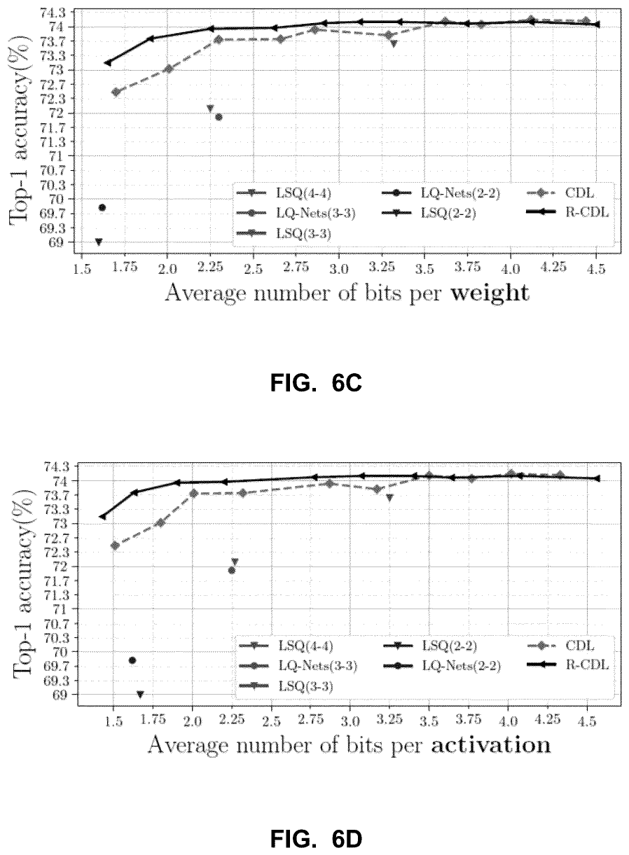

FIG. 6A-6D illustrate the performance of the top-1 accuracy (the proportion of examples for which the predicted top-1 label matches the single actual target label) vs. the number of bits required to encode the weight parameters and activations for models trained by the benchmark methods and the implementations of the methods described herein using the ImageNet dataset.

FIG. 6A shows the top-1 accuracy vs. the number of bits required to encode the weight parameters for the ResNet-18 models trained by each of the benchmark methods and the implementations of the methods described herein. FIG. 6B shows the top-1 accuracy vs. the number of bits required to encode the activations for the ResNet-18 models trained by each of the benchmark methods and the implementations of the methods described herein.

FIG. 6C shows the top-1 accuracy vs. the number of bits required to encode the weight parameters for the ResNet-34 models trained by each of the benchmark methods and the implementations of the methods described herein. FIG. 6D shows the top-1 accuracy vs. the number of bits required to encode the activations for the ResNet-34 models trained by each of the benchmark methods and the implementations of the methods described herein.

As can be seen from FIGS. 6A-6D, the implementations of the methods described herein provide an improved accuracy-compression performance as compared to almost all benchmark methods tested.

To further demonstrate the performance gain delivered only by the proposed quantization function Qₚ(·) and Q_{d}(·), the inventors tested Algorithm 1 with the objective function hyperparameters set to zero (i.e. (λ, γ)=(0,0)), and quantization bit sizes b={2,3,4}. The corresponding results for both ResNet-18 and ResNet-34 on ImageNet are listed in Table 1. For each configuration tested, Table 1 shows the top-1 accuracy, average number of bits per weight parameter, and average number of bits per activation for deep learning models trained with the hyperparameters (λ, γ)=(0,0) and quantization bit size b={2,3,4}.

TABLE 1

| Model | Method | b = 4 | b = 3 | b = 2 |
|---|---|---|---|---|
| ResNet-18 | Probabilistic | (70.45%, | (69.72%, | (67.13%, |
| | Quantizer | 3.08, 3.18) | 2.25, 2.23) | 1.50, 1.66) |
| | Deterministic | (70.50%, | (69.95%, | (67.88%, |
| | Quantizer | 2.88, 2.76) | 2.10, 2.12) | 1.40, 1.51) |
| ResNet-34 | Probabilistic | (73.80%, | (73.01%, | (70.88%, |
| | Quantizer | 3.33, 3.31) | 2.25, 2.34) | 1.55, 1.52) |
| | Deterministic | (73.92%, | (73.25%, | (71.44%, |
| | Quantizer | 3.04, 3.12) | 2.20, 2.29) | 1.45, 1.46) |

As can be seen from FIGS. 6A-6D and Table 1, the accuracy of the models trained using a deterministic quantization approximation was found to be above the models trained using the probabilistic quantizer. This may be the result of the gradient calculations being performed with no approximations when the deterministic quantization approximation is used.

As can be seen from FIGS. 6A-6D and Table 1, the models trained using the disclosed methods can provide slightly higher test accuracy compared to the respective pre-trained full-precision models while achieving significant compression. For example, ResNet-18 trained by the methods using a deterministic quantization approximation showed 70.55% accuracy (slightly better than the 70.5% accuracy for benchmark full-precision models) with 2.34 bits per weight, achieving more than 13 fold compression. Similarly, ResNet-18 trained by the methods using a probabilistic quantization function showed 70.52% accuracy (slightly better than the 70.5% accuracy for benchmark full-precision models) with 3.34 bits per weight, achieving more than 9 fold compression. Similar results were seen for ResNet-34 as well.

When low bit rates are used, the accuracy of the models trained using the disclosed methods was seen to be significantly better than the accuracy of the models trained using benchmark methods. Additionally, the use of the probabilistic quantization function and deterministic quantization approximation alone outperformed benchmark quantization methods in terms of model accuracy.

Implementations of the disclosed methods were also tested using the CIFAR-100 dataset as a training dataset. The CIFAR-100 dataset contains 50K training and 10K test images of size 32×32, which are labeled for 100 classes. The disclosed methods were used to train deep neural network models from three different model architectural families, namely: (i) four models from the ResNet family (see K. He, X. Zhang, S. Ren, and J. Sun, “Deep residual learning for image recognition,” in Proceedings of the IEEE conference on computer vision and pattern recognition, 2016, pp. 770-778), ResNet-{20, 44, 56, 110}; (ii) VGG-13 from the VGG family (see K. Simonyan and A. Zisserman, “Very deep convolutional networks for large-scale image recognition,” arXiv preprint arXiv: 1409.1556, 2014); and (iii) Wide-ResNet-28-10 from the Wide-ResNet family (see S. Zagoruyko and N. Komodakis, “Wide Residual Networks,” in British Machine Vision Conference 2016. York, France: British Machine Vision Association, January 2016). The deep neural network models were trained from scratch using an implementation of the disclosed methods employing a probabilistic quantizer and an implementation of the disclosed methods employing a deterministic quantization approximation. The results of the training were compared against models trained using LSQ training methods either on top of pre-trained models (denoted as P-LSQ) or from scratch (denoted as S-LSQ)

The methods were trained using a stochastic gradient descent optimizer with a momentum of 0.9, a weight decay of 0.0005, and a batch size of 64. The models were trained for 200 epochs, and adopted an initial learning rate of 0.1, which was further divided by 10 at the 60-th, 120-th and 160-th epochs. The disclosed methods were implemented using Algorithm 1 for different pairs of the hyperparameters λ and γ values, namely (λ, γ)={(0,0), (0.01,0.01), . . . , (0.09,0.09)}.

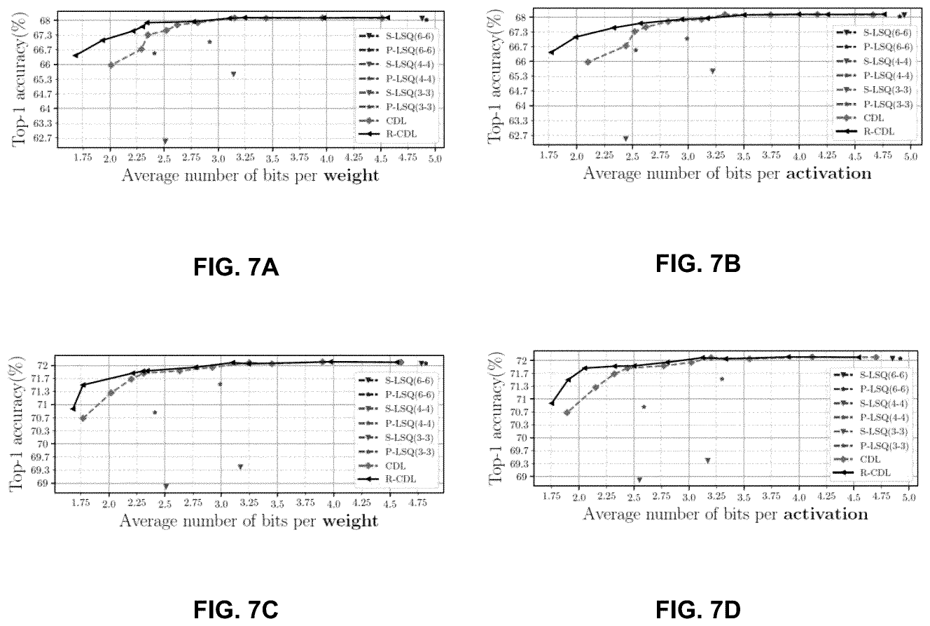

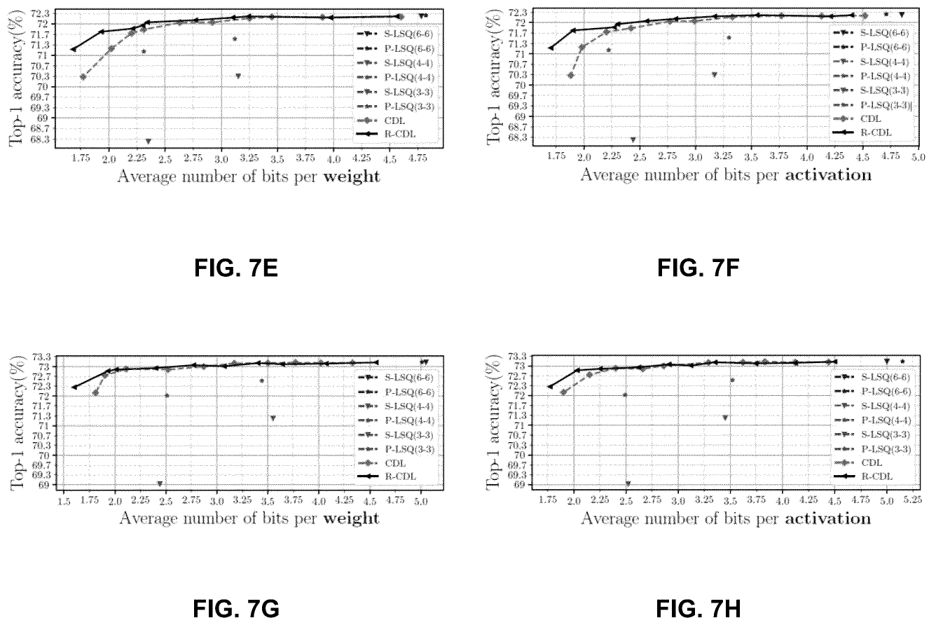

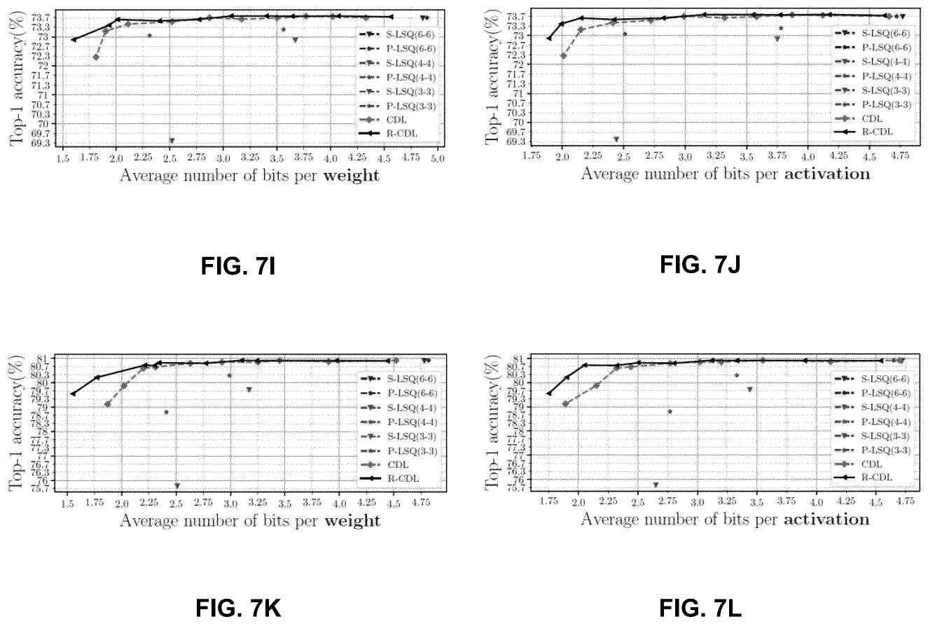

FIGS. 7A-7L illustrate the performance of the top-1 accuracy vs. the number of bits required to encode the weight parameters and activations for models trained by the benchmark methods and the implementations of the methods described herein using the CIFAR-100 dataset. FIGS. 7A-7B show the results for the ResNet-20 model; FIGS. 7C-7D show the results for the ResNet-44; FIGS. 7E-7F show the results for the ResNet-56; FIGS. 7G-7H show the results for the ResNet-110; FIGS. 7I-7J show the results for the VGG-13; and FIGS. 7K-7L show the results for the Wide-ResNet-28-10. The results are again similar to those found with the models trained using the ImageNet dataset, namely slightly improved accuracy and greatly improved compressiong for the deep neural networks trained using the disclosed models. The results also show that the difference in accuracy between the models trained using a deterministic quantization approximation and the models trained using the probabilistic quantizer decreases as the model size increases.

The inventors also tested the validation accuracy of the disclosed methods when training is initialized from pre-trained models. The results of this testing were compare to the benchmark training methods previously tested as well as two additional benchmark methods, namely APoT (see Y. Li, X. Dong, and W. Wang, “Additive powers-of-two quantization: An efficient non-uniform discretization for neural networks,” in International Conference on Learning Representations, 2019) and DMBQ (see S. Zhao, T. Yue, and X. Hu, “Distribution-aware adaptive multi-bit quantization,” in Proceedings of the IEEE/CVF Conference on Computer Vision and Pattern Recognition, 2021, pp. 9281-9290). Each of the training methods was applied on top of pre-trained models for the ImageNet dataset with the same training settings applied as for the other test cases described above.

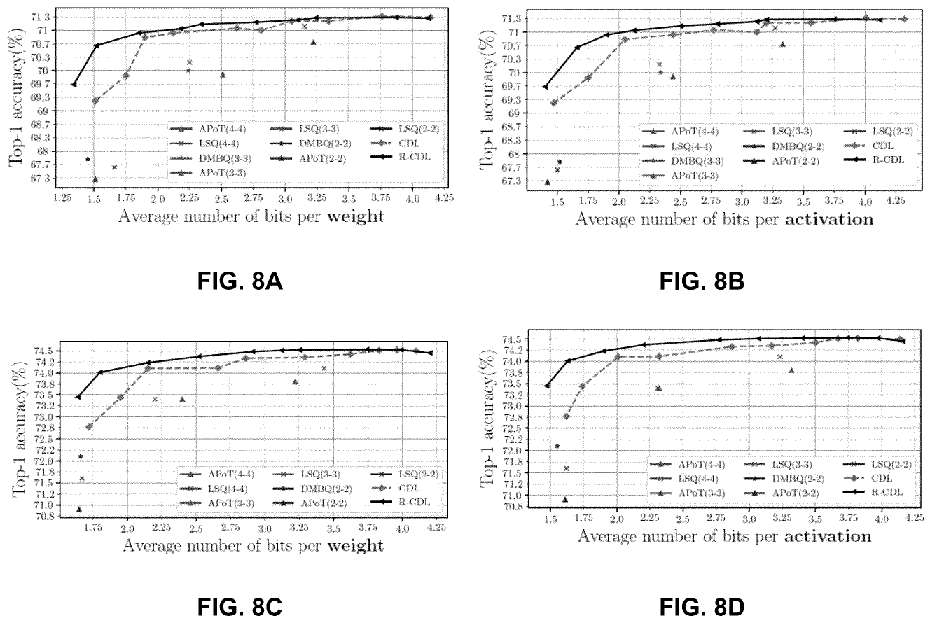

FIG. 8A-8D illustrate the performance of the top-1 accuracy (the proportion of examples for which the predicted top-1 label matches the single actual target label) vs. the number of bits required to encode the weight parameters and activations for models retrained by the benchmark methods and the implementations of the methods described herein using the ImageNet dataset.

FIG. 8A shows the top-1 accuracy vs. the number of bits required to encode the weight parameters for the ResNet-18 models retrained by each of the benchmark methods and the implementations of the methods described herein. FIG. 8B shows the top-1 accuracy vs. the number of bits required to encode the activations for the ResNet-18 models retrained by each of the benchmark methods and the implementations of the methods described herein.

FIG. 8C shows the top-1 accuracy vs. the number of bits required to encode the weight parameters for the ResNet-34 models retrained by each of the benchmark methods and the implementations of the methods described herein. FIG. 8D shows the top-1 accuracy vs. the number of bits required to encode the activations for the ResNet-34 models retrained by each of the benchmark methods and the implementations of the methods described herein.

As can be seen from FIGS. 8A-8D, the implementations of the methods described herein provide an improved accuracy-compression performance as compared to almost all benchmark methods tested. The disclosed methods continue to outperform the benchmark methods when applied on top of pre-trained full-precision models with the gains offered by the disclosed methods being quite significant at low bits.

Additionally, it can be seen that the disclosed methods provide even greater accuracy-compression performance when applied on top of pre-trained FP models in comparison with starting from the scratch. When applied on top of pre-trained FP models, the disclosed methods can improve the accuracy performance of the pre-trained FP models by a non-negligible margin.

While the above description provides examples of one or more methods or apparatuses or systems, it will be appreciated that other methods or apparatuses or systems may be within the scope of the accompanying claims.

It will be appreciated that the embodiments described in this disclosure may be implemented in a number of computing devices, including, without limitation, servers, suitably-programmed general purpose computers, cameras, sensors, audio/video encoding and playback devices, set-top television boxes, television broadcast equipment, mobile devices, and autonomous vehicles. The embodiments described in this disclosure may be implemented by way of hardware or software containing instructions for configuring a processor or processors to carry out the functions described herein. The software instructions may be stored on any suitable non-transitory computer readable memory, including CDs, RAM, ROM, Flash memory, etc.

It will be understood that the embodiments described in this disclosure and the module, routine, process, thread, or other software component implementing the described methods/processes/frameworks may be realized using standard computer programming techniques and languages. The present application is not limited to particular processors, computer languages, computer programming conventions, data structures, other such implementation details. Those skilled in the art will recognize that the described methods/processes may be implemented as a part of computer-executable code stored in volatile or non-volatile memory, as part of an application-specific integrated chip (ASIC), etc.

As will be apparent to a person of skill in the art, certain adaptations and modifications of the described methods/processes/frameworks can be made, and the above discussed embodiments should be considered to be illustrative and not restrictive.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A method of training a deep neural network, the deep neural network comprising a plurality of layers, the plurality of layers including a plurality of intermediate layers arranged between an input layer and an output layer, wherein each intermediate layer has a plurality of weight parameters, and wherein each intermediate layer is operable to output one or more activations to an adjacent layer in the plurality of layers, the method comprising:
inputting a plurality of training data samples into the input layer of the deep neural network, wherein the plurality of training data samples are contained within a training set used to train the deep neural network; and
generating a trained deep neural network using the plurality of training data samples by iteratively updating the plurality of weight parameters to optimize an entropy constrained objective function, wherein the entropy constrained objective function is defined to jointly minimize a quantized loss function of the deep neural network and an entropy of a plurality of quantized weight values, wherein the plurality of quantized weight values correspond to the plurality of weight parameters and each quantized weight value is a quantized representation of a corresponding weight parameter in the plurality of weight parameters.

2. The method of claim 1, wherein the entropy constrained objective function is defined using a plurality of quantization function trainable parameters, and generating the trained deep neural network comprises iteratively updating the quantization function trainable parameters along with the plurality of weight parameters to optimize the entropy constrained objective function.

3. The method of claim 2, wherein the plurality of quantization function trainable parameters comprises a plurality of quantization function trainable parameter sets, wherein each quantization function trainable parameter set corresponds to a particular quantization function trainable parameter type, and the quantization function trainable parameter set for each quantization function trainable parameter type includes a plurality of layer-specific quantization function trainable parameters, wherein each layer-specific quantization function trainable parameter is associated with a particular layer of the plurality of layers of the deep neural network.

4. The method of claim 1, wherein each quantized weight value is determined from the corresponding weight parameter using a probabilistic weight quantization function that defines a random mapping between a given weight parameter and the corresponding quantized weight value.

5. The method of claim 4, wherein iteratively updating the plurality of weight parameters comprises, for each iteration, calculating a gradient of the entropy constrained objective function, wherein calculating the gradient comprises a combination of backpropagation over the layers of the deep neural network and using a deterministic weight quantization function as an approximation of the probabilistic weight quantization function to calculate partial derivatives of the entropy constrained objective function.

6. The method of claim 4, wherein each quantized weight value corresponds to a potential quantized weight value from a plurality of potential quantized weight values, and the random mapping is defined using a conditional probability mass function defined to calculate a plurality of mapping probabilities for each weight parameter, wherein each mapping probability for a given weight parameter indicates a probability of that given weight parameter being quantized to one of the potential quantized weight values in the plurality of potential quantized weight values.

7. The method of claim 1, wherein the entropy constrained objective function is defined to jointly minimize the quantized loss function, the entropy of the plurality of quantized weight values, and an entropy of a plurality of quantized activation values, wherein the plurality of quantized activation values correspond to a plurality of activations, wherein the plurality of activations includes the one or more activations provided by each intermediate layer in the plurality of layers, and each quantized activation value is a quantized representation of a corresponding activation in the plurality of activations.

8. The method of claim 7, wherein each quantized activation value is determined from the corresponding activation using a probabilistic activation quantization function that defines a random mapping between a given activation and the corresponding quantized activation value, and iteratively updating the plurality of weight parameters comprises, for each iteration, calculating a gradient of the entropy constrained objective function, wherein calculating the gradient comprises a combination of backpropagation over the layers of the deep neural network and using a deterministic activation quantization function as an approximation of the probabilistic activation quantization function to calculate partial derivatives of the entropy constrained objective function.

9. The method of claim 7, wherein each quantized activation value is a partially quantized activation value determined from the corresponding activation using a deterministic activation quantization function.

10. The method of claim 9, wherein the deterministic activation quantization function is configured to define the partially quantized activation value as a weighted average value of a probabilistic quantized activation value determined from the corresponding activation using a probabilistic activation quantization function that defines a random mapping between a given activation and the corresponding quantized activation value.

11. The method of claim 9, wherein the trained deep neural network is generated using a plurality of training computing devices, wherein each training computing device is associated with one or more layers of the plurality of layers and generating the trained deep neural network comprises transmitting activations between the plurality of training computing devices, wherein prior to transmitting the activations, each activation is quantized into a corresponding quantized activation value determined from the corresponding activation using a probabilistic activation quantization function that defines a random mapping between a given activation and the corresponding quantized activation value.

12. The method of claim 1, wherein each quantized weight value is a partially quantized weight value determined from the corresponding weight parameter using a deterministic weight quantization function.

13. The method of claim 12, wherein the deterministic weight quantization function is configured to define the partially quantized weight value as a weighted average value of a probabilistic quantized weight value determined from the corresponding weight parameter using a probabilistic weight quantization function that defines a random mapping between a given weight parameter and the corresponding quantized weight value.

14. The method of claim 12, wherein the trained deep neural network is generated using a plurality of training computing devices, wherein each training computing device is associated with a device specific batch of training data samples in the plurality of training data samples, and generating the trained deep neural network comprises transmitting weight parameters between the plurality of training computing devices, wherein prior to transmitting the weight parameters, each weight parameter is quantized into a corresponding quantized weight value determined from the corresponding weight parameter using a probabilistic weight quantization function that defines a random mapping between a given weight and the corresponding quantized weight value.

15. The method of claim 1, further comprising:
generating a quantized plurality of trained weight parameters by, after generating the trained deep learning model, quantizing the plurality of weight parameters using a probabilistic weight quantization function that defines a random mapping between a given weight parameter and the corresponding quantized weight value; and
storing the trained deep neural network by storing the quantized plurality of trained weight parameters in one or more non-transitory data storage elements.

16. A computer program product for training a deep neural network, the deep neural network comprising a plurality of layers, the plurality of layers including a plurality of intermediate layers arranged between an input layer and an output layer, wherein each intermediate layer has a plurality of weight parameters, and wherein each intermediate layer is operable to output one or more activations to an adjacent layer in the plurality of layers, the computer program product comprising a non-transitory computer readable medium having computer executable instructions stored thereon, the instructions for configuring one or more processors to perform a method of training the deep neural network, wherein the method comprises:
inputting a plurality of training data samples into the input layer of the deep neural network, wherein the plurality of training data samples are contained within a training set used to train the deep neural network; and
generating a trained deep neural network using the plurality of training data samples by iteratively updating the plurality of weight parameters to optimize an entropy constrained objective function, wherein the entropy constrained objective function is defined to jointly minimize a quantized loss function of the deep neural network and an entropy of a plurality of quantized weight values, wherein the plurality of quantized weight values correspond to the plurality of weight parameters and each quantized weight value is a quantized representation of a corresponding weight parameter in the plurality of weight parameters.

17. The computer program product of claim 16, wherein the entropy constrained objective function is defined using a plurality of quantization function trainable parameters, and generating the trained deep neural network comprises iteratively updating the quantization function trainable parameters along with the plurality of weight parameters to optimize the entropy constrained objective function.

18. The computer program product of claim 17, wherein the plurality of quantization function trainable parameters comprises a plurality of quantization function trainable parameter sets, wherein each quantization function trainable parameter set corresponds to a particular quantization function trainable parameter type, and the quantization function trainable parameter set for each quantization function trainable parameter type includes a plurality of layer-specific quantization function trainable parameters, wherein each layer-specific quantization function trainable parameter is associated with a particular layer of the plurality of layers of the deep neural network.

19. The computer program product of claim 16, wherein each quantized weight value is determined from the corresponding weight parameter using a probabilistic weight quantization function that defines a random mapping between a given weight parameter and the corresponding quantized weight value.

20. The computer program product of claim 19, wherein iteratively updating the plurality of weight parameters comprises, for each iteration, calculating a gradient of the entropy constrained objective function, wherein calculating the gradient comprises a combination of backpropagation over the layers of the deep neural network and using a deterministic weight quantization function as an approximation of the probabilistic weight quantization function to calculate partial derivatives of the entropy constrained objective function.

21. The computer program product of claim 19, wherein each quantized weight value corresponds to a potential quantized weight value from a plurality of potential quantized weight values, and the random mapping is defined using a conditional probability mass function defined to calculate a plurality of mapping probabilities for each weight parameter, wherein each mapping probability for a given weight parameter indicates a probability of that given weight parameter being quantized to one of the potential quantized weight values in the plurality of potential quantized weight values.

22. The computer program product of claim 16, wherein the entropy constrained objective function is defined to jointly minimize the quantized loss function, the entropy of the plurality of quantized weight values, and an entropy of a plurality of quantized activation values, wherein the plurality of quantized activation values correspond to a plurality of activations, wherein the plurality of activations includes the one or more activations provided by each intermediate layer in the plurality of layers, and each quantized activation value is a quantized representation of a corresponding activation in the plurality of activations.

23. The computer program product of claim 22, wherein each quantized activation value is determined from the corresponding activation using a probabilistic activation quantization function that defines a random mapping between a given activation and the corresponding quantized activation value, and iteratively updating the plurality of weight parameters comprises, for each iteration, calculating a gradient of the entropy constrained objective function, wherein calculating the gradient comprises a combination of backpropagation over the layers of the deep neural network and using a deterministic activation quantization function as an approximation of the probabilistic activation quantization function to calculate partial derivatives of the entropy constrained objective function.

24. The computer program product of claim 22, wherein each quantized activation value is a partially quantized activation value determined from the corresponding activation using a deterministic activation quantization function.

25. The computer program product of claim 24, wherein the deterministic activation quantization function is configured to define the partially quantized activation value as a weighted average value of a probabilistic quantized activation value determined from the corresponding activation using a probabilistic activation quantization function that defines a random mapping between a given activation and the corresponding quantized activation value.

26. The computer program product of claim 24, wherein the trained deep neural network is generated using a plurality of training computing devices, wherein each training computing device is associated with one or more layers of the plurality of layers and generating the trained deep neural network comprises transmitting activations between the plurality of training computing devices, wherein prior to transmitting the activations, each activation is quantized into a corresponding quantized activation value determined from the corresponding activation using a probabilistic activation quantization function that defines a random mapping between a given activation and the corresponding quantized activation value.

27. The computer program product of claim 16, wherein each quantized weight value is a partially quantized weight value determined from the corresponding weight parameter using a deterministic weight quantization function.

28. The computer program product of claim 27, wherein the deterministic weight quantization function is configured to define the partially quantized weight value as a weighted average value of a probabilistic quantized weight value determined from the corresponding weight parameter using a probabilistic weight quantization function that defines a random mapping between a given weight parameter and the corresponding quantized weight value.

29. The computer program product of claim 27, wherein the trained deep neural network is generated using a plurality of training computing devices, wherein each training computing device is associated with a device specific batch of training data samples in the plurality of training data samples, and generating the trained deep neural network comprises transmitting weight parameters between the plurality of training computing devices, wherein prior to transmitting the weight parameters, each weight parameter is quantized into a corresponding quantized weight value determined from the corresponding weight parameter using a probabilistic weight quantization function that defines a random mapping between a given weight and the corresponding quantized weight value.

30. The computer program product of claim 16, wherein the method comprises:
generating a quantized plurality of trained weight parameters by, after generating the trained deep learning model, quantizing the plurality of weight parameters using a probabilistic weight quantization function that defines a random mapping between a given weight parameter and the corresponding quantized weight value; and
storing the trained deep neural network by storing the quantized plurality of trained weight parameters in one or more non-transitory data storage elements.

31. A system for training a deep neural network, the deep neural network comprising a plurality of layers, the plurality of layers including a plurality of intermediate layers arranged between an input layer and an output layer, wherein each intermediate layer has a plurality of weight parameters, and wherein each intermediate layer is operable to output one or more activations to an adjacent layer in the plurality of layers, the system comprising:
one or more processors; and
one or more non-transitory storage mediums;
wherein
the one or more processors are configured to:
input a plurality of training data samples into the input layer of the deep neural network, wherein the plurality of training data samples are contained within a training set used to train the deep neural network;
generate a trained deep neural network using the plurality of training data samples by iteratively updating the plurality of weight parameters to optimize an entropy constrained objective function, wherein the entropy constrained objective function is defined to jointly minimize a quantized loss function of the deep neural network and an entropy of a plurality of quantized weight values, wherein the plurality of quantized weight values correspond to the plurality of weight parameters and each quantized weight value is a quantized representation of a corresponding weight parameter in the plurality of weight parameters; and
storing the trained deep neural network by storing a plurality of trained weight parameters in the one or more non-transitory data storage mediums.
